(19) United States
(12) Patent Application Publication
(10) Pub. No.: US 2026/0290311 A1
(43) Pub. Date: Sep. 24, 2026

(54) SYSTEM

(71) Applicant: SoftBank Group Corp., Tokyo (JP)

(72) Inventor: Hailong ZHENG, Tokyo (JP)

(73) Assignee: SoftBank Group Corp., Tokyo (JP)

(21) Appl. No.: 19/567,026

(22) Filed: Mar. 14, 2026

(30) Foreign Application Priority Data
Mar. 19, 2025 (JP) 2025-045222

(51) Int. Cl. G10L 13/04; G10L 13/027; G10L 13/10; G10L 15/22; G10L 25/63

(52) U.S. Cl. CPC G10L 13/04; G10L 13/027; G10L 13/10; G10L 15/22; G10L 25/63

(57) ABSTRACT

A system includes a processor that is configured to receive voice data as input, analyze a voice signal by using a voice processing technique, extract voice features from the voice signal, and convert the voice features into a text format, receive text information as input and generate a first prompt for instructing a generative AI model to imitate a manner of speaking and thinking of a specific person on the basis of the text information, and recognize an emotion of a user and generate a second prompt for instructing adjustment of at least one of a tone and the manner of speaking of a voice of the specific person in accordance with the emotion of the user.

### CROSS-REFERENCE TO RELATED APPLICATION

This application is based on and claims priority under 35 USC 119 from Japanese Patent Application No. 2025-045222 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for reproducing or simulating a specific person's voice and conversational style typically rely on either mere voice conversion technologies or simple text-based chatbot techniques. Such systems generally fail to capture, in an integrated manner, both the acoustic characteristics of the person's voice and the person's characteristic manner of speaking and thinking. Furthermore, these systems do not adequately adapt the generated voice and language output to the emotional state of a user during interaction. As a result, the user often experiences a mismatch between the intended persona and the system's responses, leading to reduced realism, low immersion, and a lack of personalized communication. Therefore, there is a need for a system that is capable of: (i) analyzing voice data to extract voice features and convert them to text, (ii) generating prompts that enable a generative AI model to imitate a specific person's manner of speaking and thinking based on text information, and (iii) recognizing a user's emotion and dynamically adjusting the tone and manner of speaking of the specific person's voice in accordance with the recognized emotion, while also effectively handling different types of text information such as the person's own records, online dialogues, and third-party descriptions.

### SUMMARY

In order to solve the above-described problems, according to one aspect, there is provided a system comprising a processor, wherein the processor is configured to receive voice data as input, analyze a voice signal by using a voice processing technique, extract voice features from the voice signal, and convert the voice features into a text format. The processor is further configured to receive text information as input and generate a first prompt for instructing a generative AI model to imitate a manner of speaking and thinking of a specific person on the basis of the text information. The processor is also configured to recognize an emotion of a user and generate a second prompt for instructing adjustment of at least one of a tone and the manner of speaking of a voice of the specific person in accordance with the emotion of the user. In one embodiment, the processor is configured to convert the text information into a format suitable for the generative AI model by preprocessing the text information, the text information being at least one of a record of the specific person and a dialogue content of the specific person on an online platform. In another embodiment, the processor is configured to analyze the text information and extract characteristics of the specific person from the text information, the text information being description information about the specific person provided by another person. By these means, the system can accurately construct prompts that cause the generative AI model to reproduce both the voice tone and the cognitive-linguistic style of the specific person, while adaptively reflecting the user's emotional state in the generated voice output.

The term “system” refers to an apparatus or a combination of hardware and software components that collectively execute one or more functions described in the present specification and claims.

The term “processor” refers to any circuit, component, or combination of components capable of executing instructions, performing arithmetic or logical operations, and controlling data flow, including but not limited to a central processing unit (CPU), a graphics processing unit (GPU), a digital signal processor (DSP), an application-specific integrated circuit (ASIC), or a field-programmable gate array (FPGA).

The term “voice data” refers to digital data representing an acoustic signal produced by human speech, including raw audio waveforms and encoded audio files in formats such as WAV, MP3, or other audio formats.

The term “voice signal” refers to an analog or digital representation of sound generated by human speech, which can be analyzed to derive acoustic features such as pitch, tone, and spectral characteristics.

The term “voice processing technique” refers to any signal processing or machine learning method for analyzing a voice signal, including but not limited to noise reduction, feature extraction, speech recognition, and speaker characterization.

The term “voice features” refers to parameters or representations extracted from a voice signal that characterize properties of the speech, including but not limited to pitch, formants, timbre, spectral envelope, prosody, and speaker-specific characteristics.

The term “text format” refers to a data representation in which information is expressed as a sequence of characters or symbols that can be processed as text by a computer system, including natural language text and structured textual data.

The term “text information” refers to information represented in textual form, including but not limited to written records, transcripts, dialogue logs, and descriptive sentences relating to a specific person.

The term “generative AI model” refers to an artificial intelligence model configured to generate content, such as text, audio, or other data, based on input data or prompts, and includes, for example, a generative language model of the GPT type.

The term “prompt” refers to input data or a set of instructions provided to a generative AI model to condition, guide, or constrain the output generated by the generative AI model, including textual instructions, examples, or context information.

The term “specific person” refers to a particular individual whose manner of speaking, thinking, or vocal characteristics are to be imitated or reproduced by the system.

The term “manner of speaking” refers to a characteristic style of using language by a specific person, including but not limited to word choice, sentence structure, typical expressions, politeness level, and habitual phrases.

The term “manner of thinking” refers to characteristic patterns in how a specific person reasons, expresses opinions, or reacts to topics, including preferences, viewpoints, and typical ways of structuring thoughts.

The term “user” refers to an individual who operates or interacts with the system and who provides inputs such as voice data, text information, or conversational messages, and whose emotion may be recognized by the system.

The term “emotion of a user” refers to an affective state of the user, such as happiness, sadness, anger, fear, surprise, or neutrality, which can be inferred from user inputs including voice, text, facial expressions, or other signals.

The term “record of the specific person” refers to text information directly produced by the specific person, including but not limited to diaries, letters, emails, notes, and other personal writings.

The term “dialogue content of the specific person on an online platform” refers to text information representing messages, posts, comments, or conversations authored by the specific person on social networks, chat services, forums, or other online communication platforms.

The term “preprocessing” refers to operations applied to raw data, such as cleaning, normalization, segmentation, filtering, and formatting, to convert the data into a form suitable for processing by the generative AI model.

The term “format suitable for the generative AI model” refers to a structured representation of data, including tokenized text or annotated sequences, that conforms to input requirements or training specifications of the generative AI model.

The term “description information about the specific person provided by another person” refers to text information written or spoken by individuals other than the specific person, such as testimonials, profiles, comments, or narratives describing the specific person's characteristics, behaviors, or personality.

The term “characteristics of the specific person” refers to attributes or features associated with the specific person, including linguistic style, personality traits, behavioral tendencies, preferences, and other identifiable patterns inferred from text information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

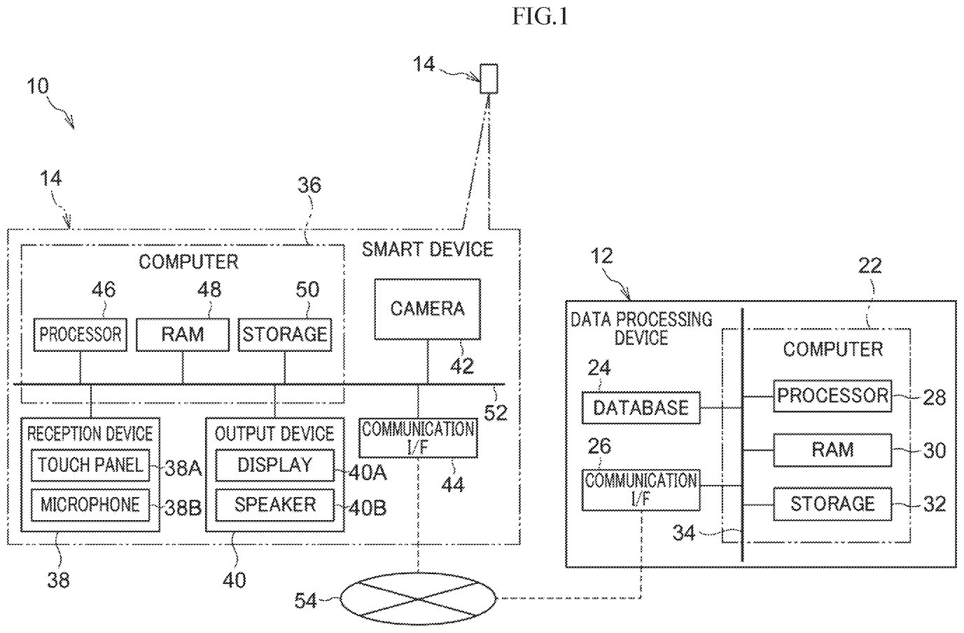

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

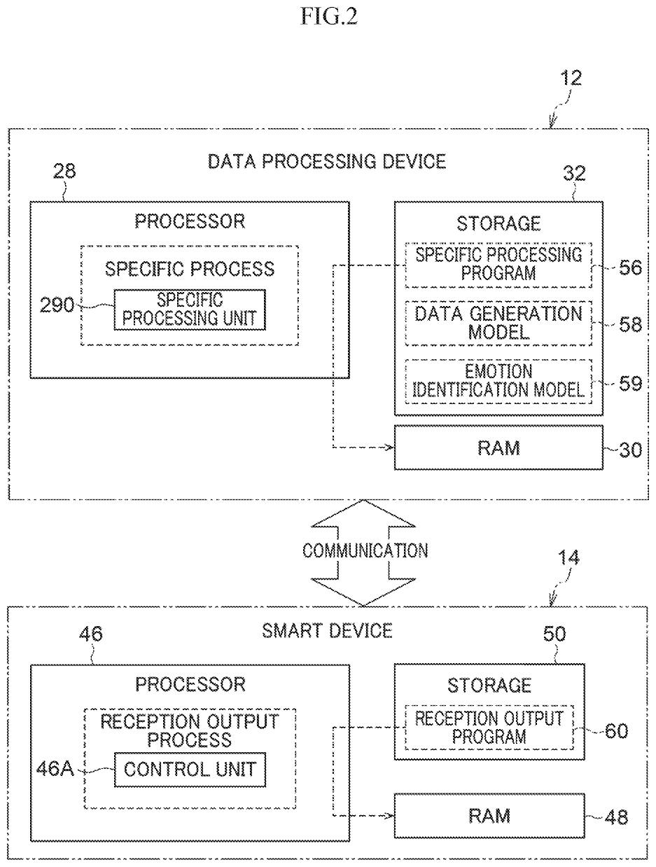

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional speech synthesis and style imitation systems suffer from several technical limitations when implemented on generic information processing hardware. First, systems that merely concatenate a generic text-to-speech engine with a generic language model typically process acoustic signals and linguistic style independently, without a unified data representation. As a result, such systems cannot reliably maintain consistency between a synthesized voice quality and the linguistic style attributed to a specific person, and frequently produce artifacts such as mismatched intonation, unnatural prosody, or semantically inconsistent utterances. This leads to degraded machine performance in terms of latency, accuracy of imitation, and robustness under varying input conditions.

Second, known systems generally accept pre-formatted text as a static input to a speech synthesizer, without dynamically generating and conditioning internal prompts for a generative AI model. In these architectures, the processing unit does not manage a dedicated language feature profile for a target speaker, nor does it create or update prompt sentences in a structured way. Consequently, the processor cannot efficiently reuse learned acoustic and linguistic features across multiple generation requests, which results in redundant computation, suboptimal resource utilization, and increased response time on computing hardware.

Third, many systems rely on ad hoc integration between emotion recognition and voice generation components. Emotional state information, if used at all, is often applied only at a superficial parameter level in the synthesizer, without coordinated adaptation at both the language generation layer and the acoustic synthesis layer. This fragmented approach makes it difficult for the processor to adjust, in a controlled and repeatable manner, parameters such as intonation, volume, speaking speed, and style level in response to real-time user signals. The lack of a unified control pathway leads to instability in output quality, difficulty in scaling to multiple users and devices, and an increase in overall computational overhead due to re-processing and correction steps.

Fourth, the data pipeline from raw user inputs (audio recordings, dialogue histories, third-party descriptions) to internal model inputs is often implemented as a loose collection of scripts and services. These components do not consistently normalize formats, extract structured features, or maintain a persistent, machine-readable profile that can be efficiently accessed by the processor. This disjointed pipeline causes duplication of preprocessing work, hinders caching and indexing of features, and prevents optimal scheduling of generative model calls, thereby limiting throughput and scalability of the system on server-class hardware.

Accordingly, there is a need for an improved computer-implemented system in which a processor on a server coordinates: (i) extraction and storage of acoustic feature quantities and speaker embeddings from heterogeneous audio inputs; (ii) extraction and maintenance of a language feature profile from diverse text sources; (iii) generation and application of prompt sentences for a generative AI model in a structured and reusable manner; and (iv) integrated application of user emotion-based control parameters across both generative language processing and speech synthesis. Such a system should improve computer functionality itself by reducing redundant computations, enabling more efficient memory access patterns, stabilizing latency, and increasing the fidelity and controllability of person-specific speech generation across networked terminals.

The specific processing by the specific processing unit 290 of the data processing device 12 in Example 1 is realized by the following means.

The present invention provides a server comprising a processor configured to acquire audio information as input from one or more client devices, execute acoustic analysis processing to extract acoustic feature quantities and a speaker embedding vector from a time-domain or frequency-domain signal, and convert heterogeneous audio information into audio data in a unified internal format stored in a memory; to acquire character information as input from one or more data sources, execute language analysis processing to extract sentence-level or word-level structures, frequent terms, expression patterns, style indices, conversation patterns, topic preferences, and features derived from third-party descriptions, and generate and store in a storage device a language feature profile representing a speaking manner, a thinking pattern, and associated attributes of a specific person; to activate a generative language model based on the character information and external information, generate structured prompt sentences for instructing the generative language model to imitate the speaking manner and the thinking pattern of the specific person, combine the prompt sentences with the language feature profile, and output generated text indicating utterance content of the specific person; to supply the acoustic feature quantities, the speaker embedding vector, and the generated text as input to a speech synthesis model, synthesize an audio waveform by associating text information with a voice quality and prosody of the specific person, and generate audio data that imitates the voice quality and the speaking manner of the specific person; to receive, via a communication interface, a generation instruction sentence from a user as input, provide the generation instruction sentence as the prompt sentence to the generative language model to start generation processing of the generated text and the audio data, and provide resulting audio data to a terminal device via an output storage area or a communication line; and to estimate an emotional state of the user from information indicating the emotional state obtained from a sensing device or an input signal, generate control parameters for adjusting intonation, volume, speaking speed, and style level of the voice of the specific person according to the emotional state, and provide the control parameters as prompt conditions and speech synthesis conditions to the generative language model and the speech synthesis model. This enables the server-side computer system to implement a unified and stateful processing pipeline that reduces redundant preprocessing, improves cacheability and reuse of learned acoustic and linguistic profiles, coordinates language generation and speech synthesis under consistent control parameters, and thereby enhances overall system performance, scalability, and fidelity in generating person-specific speech in response to user instructions.

The term “audio information” refers to data representing sound captured by an input device, including but not limited to digitized waveforms of human speech in a time domain or frequency domain.

The term “acoustic analysis processing” refers to computational operations performed on audio information to derive numerical representations of sound characteristics, such as spectral features, temporal features, and statistical descriptors, for use in subsequent modeling.

The term “acoustic feature quantities” refers to numerical values derived from audio signals, including but not limited to cepstral coefficients, spectral envelopes, pitch contours, energy measures, and other parameters that characterize timbre and prosody.

The term “speaker embedding vector” refers to a fixed-length numerical representation generated by a machine learning model that characterizes speaker-specific properties of a voice, such as timbre, speaking style, and prosodic tendencies.

The term “unified format” refers to a standardized internal representation of data, such as a specific sampling rate, bit depth, channel configuration, or encoding scheme, used to normalize heterogeneous input data into a consistent format for processing.

The term “character information” refers to text-based data, including transcribed speech, written documents, dialogue histories, or descriptive texts, that are used to characterize a person's language usage or attributes.

The term “language analysis processing” refers to computational operations applied to character information to extract structural, semantic, and stylistic features, such as tokenization, part-of-speech tagging, parsing, embedding computation, and statistical analysis.

The term “sentence-level or word-level structures” refers to syntactic and grammatical relationships among words and sentences, including sentence boundaries, phrase structures, dependency relations, and part-of-speech labels.

The term “frequent terms” refers to words, phrases, or n-grams that appear with relatively high frequency in character information associated with a specific person or domain.

The term “expression patterns” refers to recurring combinations of words or phrases, sentence templates, and typical ways of expressing intentions or emotions that characterize a person's linguistic behavior.

The term “style indices” refers to numerical or categorical indicators that represent aspects of language style, including but not limited to formality, politeness level, directness, sentence length, and use of specific constructions.

The term “language feature profile” refers to a structured data set stored in a memory or storage device that aggregates linguistic features, statistics, and style descriptors representing a specific person's speaking manner and thinking pattern.

The term “speaking manner” refers to characteristic ways in which a person expresses themselves verbally, including preferred expressions, tone, formality, pacing of speech, and rhetorical patterns.

The term “thinking pattern” refers to characteristic ways in which a person organizes, prioritizes, and presents information or reasoning in language, including typical logic flow, emphasis, and perspective.

The term “external information” refers to data other than the core character information and audio information, including but not limited to metadata, user context, environment information, or third-party descriptions, that can influence generation behavior.

The term “generative language model” refers to a computational model, typically implemented as a neural network, configured to generate text or predict sequences of tokens based on input prompts and learned statistical patterns from training data.

The term “prompt sentence” refers to a text instruction or query provided to a generative language model to specify or constrain the content, style, or behavior of generated text.

The term “generated text” refers to text output produced by a generative language model in response to a prompt sentence and associated conditions, representing predicted or synthesized utterance content.

The term “speech synthesis model” refers to a computational model, including but not limited to a neural network, that converts text or intermediate acoustic representations into audio waveforms simulating human speech.

The term “voice quality” refers to perceived characteristics of a voice, such as timbre, color, and resonance, that distinguish one speaker from another.

The term “prosody” refers to suprasegmental aspects of speech, including intonation, rhythm, stress, and timing, that affect how utterances sound and convey emphasis or emotion.

The term “audio data” refers to a digital representation of sound, typically stored as a sequence of samples or encoded in a file format, suitable for storage, transmission, or playback.

The term “generation instruction sentence” refers to a user-provided text input that specifies what content should be generated and under what conditions, and that is used as a prompt sentence for a generative language model.

The term “terminal device” refers to an information processing device operated by a user, including but not limited to a mobile device, a personal computer, a tablet device, or a dedicated appliance, capable of sending requests to and receiving responses from a server.

The term “output storage area” refers to a logical or physical storage region, such as a file system directory, database, or object store, used to store generated audio data or related results for later access or transfer.

The term “communication line” refers to a communication path, including wired and wireless networks, that enables data exchange between a server and one or more terminal devices.

The term “emotional state” refers to a condition of affect or mood of a user, such as happiness, sadness, anger, or calmness, inferred from signals including physiological data, facial expressions, voice characteristics, or input behavior.

The term “sensing device” refers to hardware configured to capture signals relevant to a user's state, including but not limited to cameras, microphones, physiological sensors, touch interfaces, or motion sensors.

The term “control parameters” refers to numerical or symbolic values used to adjust operation of a model or processing pipeline, such as parameters specifying intonation level, volume level, speaking speed, or style level for generated speech.

The term “intonation” refers to pitch variations over time in spoken language that contribute to the melody of speech, including rises, falls, and contours across an utterance.

The term “speaking speed” refers to a rate at which speech is produced, generally measured in units such as syllables per second, words per minute, or temporal spacing between phonetic units.

The term “style level” refers to a setting or descriptor indicating a degree of formality, politeness, or expressiveness applied to generated language and speech.

The term “prompt conditions” refers to additional constraints or parameters provided to a generative language model together with a prompt sentence to influence style, tone, or content of generated text.

The term “speech synthesis conditions” refers to parameters provided to a speech synthesis model to control characteristics of generated audio, such as pitch range, tempo, energy, and expressiveness.

The term “utterance records” refers to stored data representing past spoken outputs of a person, including audio recordings and associated transcriptions.

The term “recording medium” refers to a storage medium, such as a magnetic, optical, or semiconductor medium, used to record and store audio or text data.

The term “dialogue histories” refers to stored sequences of interactions, including messages, turns, or conversational exchanges, between one or more participants on a communication platform or network.

The term “information processing network” refers to a communication infrastructure, such as the Internet or a local area network, that interconnects multiple information processing devices for data exchange.

The term “preprocessing” refers to a series of operations applied to raw data to convert it into a normalized and structured form, including operations such as cleaning, normalization, segmentation, and encoding.

The term “removal of unnecessary symbols” refers to a preprocessing step in which non-informative or irrelevant characters, such as noise tokens, formatting codes, or extraneous punctuation, are deleted from character information.

The term “normalization of a format” refers to converting various textual or structural layouts into a standardized representation, such as unifying character encodings, line break conventions, or punctuation styles.

The term “segmentation processing” refers to the operation of dividing a continuous stream of text into smaller units, such as sentences, clauses, or tokens, for analysis or modeling.

The term “encoding processing” refers to transforming character information into a machine-readable representation, such as a specific character encoding scheme or a vector representation suitable for model input.

The term “statistical information” refers to quantitative measures derived from data, such as frequency counts, distributions, or co-occurrence metrics, used to describe patterns in conversation or topic usage.

The term “conversation patterns” refers to regularities in how a person participates in dialogues, including turn-taking behavior, typical response structures, and preferred discourse organization.

The term “topic preferences” refers to tendencies of a person to focus on particular subjects or themes, as identified by analyzing distributions of topics or keywords across character information.

The term “explanation information” refers to descriptive text created by a third party that characterizes a specific person, including statements about personality, role, expertise, or other attributes.

The term “semantic analysis processing” refers to computational operations that identify meanings and relationships in text, such as extracting entities, roles, sentiment, or semantic relations.

The term “keyword extraction processing” refers to operations that identify important terms or phrases in text that are highly relevant to its main content or themes.

The term “feature quantities” refers to numerical or symbolic descriptors extracted from data that represent properties, such as personality traits, roles, expertise areas, or evaluation tendencies of a person.

The term “personality” refers to a set of relatively stable behavioral and attitudinal characteristics attributed to an individual, as inferred from language use or descriptive information.

The term “role” refers to a functional position or responsibility associated with a person in a social, organizational, or task context.

The term “expertise” refers to a domain or field in which a person is regarded as having specialized knowledge or skills.

The term “evaluation tendency” refers to characteristic ways in which a person evaluates or judges situations or entities, as reflected in language polarity, preference expressions, or appraisal patterns.

In one embodiment, a server, a terminal, and a user cooperate to implement a system that generates person-specific speech by integrating acoustic analysis, language profile construction, prompt-based generative language processing, and neural speech synthesis.

The server operates on a hardware platform such as a rack-mount server or a virtual machine provided by a cloud computing environment. The server includes at least one multi-core processor, a volatile memory, a non-volatile storage device, and a network interface. The server executes an operating system such as a generic server operating system and runs application programs implemented using a software framework such as a general-purpose machine learning library (for example, PyTorch or TensorFlow), a web application framework, and external service clients for speech recognition and text generation.

The terminal operates as a client device, such as a mobile communication device, a portable information terminal, or a general-purpose computer. The terminal includes an input device such as a microphone and a touch-sensitive display, an audio output device such as a loudspeaker or earphone jack, and a communication interface such as a wireless communication module. The terminal executes an application that provides user interfaces for recording audio, entering text, submitting a prompt sentence, and playing back generated speech.

The user operates the terminal to record the voice of a specific person. The terminal uses its microphone, an audio driver, and a recording application to sample analog sound at a predetermined sampling frequency (for example, 16 kHz or 44.1 kHz, 16-bit linear PCM), to buffer the sampled frames in the memory, and to write a digital audio file in a standardized format such as WAV or a compressed format such as MP3. The terminal stores file metadata such as file name, size, and recording time in a file system maintained by the terminal's operating system.

The terminal transmits the recorded audio file to the server via a communication network. The terminal establishes a secure channel using a transport layer security protocol and sends the audio file in a request message according to an application-layer protocol such as HTTP. The server receives the request at an application server module, writes the audio payload to a storage subsystem, and registers an audio record in a data store such as a relational database or an object storage service.

The server executes acoustic analysis processing on the stored audio information. The server uses an audio processing library (for example, an open-source audio analysis library) to normalize the audio to a unified format, such as single-channel, 16-bit, 16 kHz PCM. The server then computes acoustic feature quantities by segmenting the waveform into overlapping frames (for example, 25 ms windows with 10 ms shift), applying a window function such as a Hamming window, and transforming each frame into a frequency-domain representation using a fast Fourier transform. The server derives Mel-frequency cepstral coefficients, log-Mel spectrograms, energy measures, and pitch contours from these frames. The server feeds sequences of these frame-level features into a pre-trained speaker-embedding network, such as a time-delay neural network or a convolutional-recurrent architecture, to calculate a speaker embedding vector that summarizes speaker-specific characteristics.

The server stores the acoustic feature quantities and the speaker embedding vector as structured records in a feature database. The server may represent the speaker embedding as a fixed-dimension vector, for example 256 or 512 floating-point values, and may store the vector together with statistics such as average speaking rate, pitch distribution, and energy distribution. By storing these data structures in indexed tables or vector stores, the server enables efficient retrieval and reuse of learned acoustic profiles in subsequent generation requests, thereby reducing the need to re-analyze the same audio.

The user provides character information that describes the speaking manner and thinking pattern of the specific person. The terminal presents a text input interface, and the user enters sentences derived from past conversations, writings, or representative statements. The terminal encodes the text as character data and transmits it to the server via the network.

The server executes language analysis processing on the character information. The server tokenizes the text into sentences and words, applies part-of-speech tagging and dependency parsing using a natural language processing engine, and computes sentence embeddings using a neural encoder such as a transformer-based model. The server calculates distributions of word frequencies, n-gram patterns, sentence lengths, and syntactic constructions. In addition, the server may compute style indices representing formality, politeness level, directness, and other stylistic attributes based on learned style classifiers.

The server stores the extracted linguistic features in a language feature profile associated with the specific person. The language feature profile may be implemented as a structured record that includes numerical vectors (for example, average sentence embedding, style embedding), statistical tables (for example, frequency of certain discourse markers), and symbolic descriptors (for example, typical greeting templates). By keeping this profile as a persistent object in the storage device, the server avoids recomputing style features for each generation request, thus improving computational efficiency.

The server can incorporate additional sources of character information, such as dialogue histories on a communication network or descriptive texts written by third parties. The server retrieves dialogue logs from a network service, applies the same tokenization and parsing procedures, and aggregates the resulting features into the language feature profile. For third-party explanations, the server performs semantic analysis to identify phrases that describe personality, role, and expertise, and then encodes such attributes as feature quantities attached to the profile. This multi-source aggregation enables the server to construct a richer representation of the person's linguistic behavior than a human operator could manage manually, and it does so using consistent internal data structures.

The user supplies a generation instruction sentence, which serves as a prompt sentence for a generative language model running on the server. The terminal presents a prompt input field. The user may type, for example:

“In Mr. Tanaka's voice, please say: ‘Good morning, everyone. Thank you for your hard work.’”

“Please generate a short encouragement message in Mr. Tanaka's usual style for a team member who is tired.”

“In Mr. Tanaka's tone, please explain briefly why today's meeting is important.”

The terminal transmits the prompt sentence, together with an identifier of the target person, to the server.

The server activates a generative language model, which may be implemented as a transformer-based neural network with multiple attention layers. The server constructs an internal conditioning prompt by combining the user's prompt sentence with information drawn from the language feature profile. For example, the server can prepend a style description generated from the profile, such as: “Speak in a calm, polite, business tone, using concise sentences and thanking the audience frequently.” The server then feeds the combined prompt into the generative language model, which generates text token by token based on learned probability distributions.

The server configures the generative language model with parameters, such as maximum output length, temperature, and top-k or top-p sampling thresholds, to control diversity and determinism. The server optionally adjusts these parameters depending on the stored style indices, so that more formal profiles receive lower temperature and shorter maximum length, while more informal profiles allow more variation. The output of the generative language model is a generated text that both follows the instruction contained in the prompt sentence and reflects the speaking manner captured in the language feature profile.

The server applies post-processing to the generated text. The server may remove explanatory phrases that are not part of the desired utterance, ensure that quotation marks are correctly paired, and enforce limits on the total number of characters. This post-processing converts the raw generative output into a well-formed utterance suitable for speech synthesis.

The server performs speech synthesis using a speech synthesis model that supports speaker conditioning. In one embodiment, the server employs a two-stage neural architecture. In a first stage, a sequence-to-sequence model such as a Tacotron-type or VITS-type model converts the generated text into a sequence of acoustic features, such as a Mel-spectrogram. The model receives, in addition to the text tokens, the speaker embedding vector and prosody-related parameters derived from the acoustic feature quantities. In a second stage, a neural vocoder such as a generative adversarial network-based vocoder converts the Mel-spectrogram into a time-domain waveform.

The server controls the speech synthesis model using both static profile data and dynamic control parameters. The static profile data include the speaker embedding and prosody statistics stored earlier, while the dynamic parameters may include adjustments based on a current emotional state of the user. The server can estimate an emotional state from signals such as voice tone received from the terminal's microphone, interaction patterns detected by the terminal application, or external sensing devices. By mapping these inputs to control parameters specifying desired intonation level, speaking speed, and style level, the server can generate speech that reacts in real time to user state.

This integrated control pathway, where the same emotional control parameters influence both the generative language model (via prompt modification) and the speech synthesis model (via acoustic conditioning), produces more coherent and technically improved outputs than conventional isolated modules. For example, the server can generate a more sympathetic wording in the generated text while simultaneously lowering pitch and slowing speaking speed, which a basic text-to-speech pipeline cannot coordinate automatically.

The server stores the synthesized audio waveform in an output storage area, such as an object store or a file system directory, and returns a reference or the audio data itself to the terminal. The terminal downloads or streams the audio data, decodes it using an audio playback component, and drives the loudspeaker or earphone to render the sound. The user hears a voice that imitates both the voice quality and speaking manner of the specific person.

This architecture improves computer technology in several ways. Because the server separates feature extraction, feature storage, prompt construction, language generation, and speech synthesis into dedicated modules with clearly defined data structures, the server reduces redundant computation. Acoustic features and language profiles are computed once and reused across multiple generation requests, which reduces processor load and shortens response time. The use of indexed feature databases and vector representations allows the processor to perform efficient memory access and to schedule model inference operations more predictably.

Furthermore, the server applies non-conventional processing rules that are not simple automation of human tasks. Human operators do not manually compute speaker embeddings, style vectors, or Mel-spectrograms; rather, the server performs these numerical operations to enable machine-interpretable representations. The server uses explicit error functions during training phases of the neural models, such as cross-entropy loss for token prediction in the generative language model and a combination of L1 loss and adversarial loss for the speech synthesis model. The server updates model weights by applying gradient descent methods, such as stochastic gradient descent or adaptive optimization algorithms, based on backpropagated gradients computed from training data. Data augmentation techniques, such as time-stretching audio, adding noise, or paraphrasing text, may be incorporated to improve robustness.

By designing the generative language model and speech synthesis model to operate on shared conditioning signals (speaker embeddings, language feature profiles, emotion-derived control parameters), the server achieves tighter coupling between linguistic and acoustic output. This mutual conditioning reduces mismatch errors that would otherwise occur when separately trained systems are loosely integrated. As a result, the system improves accuracy in imitating a specific person's voice and style, reduces artifacts, and improves the stability of latency and throughput under high request volumes.

In alternative embodiments, the server may run different neural architectures. For example, the generative language model may be implemented as an encoder-decoder transformer with multi-head self-attention and cross-attention layers, while the speech synthesis model may be a diffusion-based model that iteratively refines a noisy waveform into a clean speech signal. The system may also support different feature extraction front-ends, such as using convolutional neural networks to learn acoustic features directly from waveforms, or using separate encoders for content and style which are then combined in a later layer.

The terminal can also vary in form. In some implementations, the terminal is a head-mounted device that uses spatial audio rendering to deliver the generated speech as part of an immersive environment. In these cases, the server may embed spatialization metadata into the audio stream, and the terminal may apply head-related transfer function processing. Such variations maintain the same essential data flow: the server constructs and uses profiles and prompt sentences to generate person-specific speech, and the terminal renders that speech using its audio output hardware.

Through these configurations, the server and the terminal cooperate to implement a concrete improvement in computer-based speech generation. The system does not merely automate human drafting and reading; rather, it restructures internal data representations and control flows so that the processor can more efficiently and accurately generate person-specific audio content while managing computational resources and communication bandwidth in a technically advantageous way.

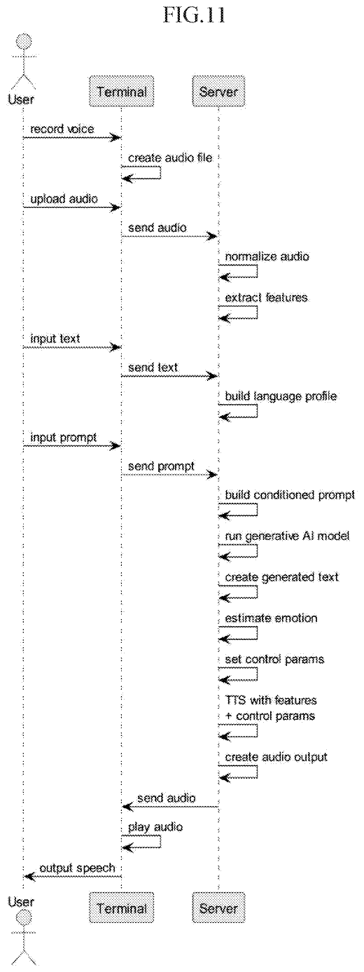

The following describes the processing flow using FIG. 11.

### Step 1

The user records voice of a specific person on the terminal.

The terminal uses its microphone and an audio recording application to sample analog sound at a fixed sampling rate (for example, 16 kHz or 44.1 kHz, 16-bit PCM), buffer the samples in memory, and encode them into a digital audio file in a standardized format such as WAV or MP3.

Input: analog speech signal produced by the specific person.

Output: digital audio file (for example, “tanaka_voice.wav”) stored in the terminal's local storage with associated file metadata (file name, size, timestamp).

The terminal starts recording when the user presses a “Record” button, continuously stores the sampled frames in a file stream, and stops and finalizes the file when the user presses a “Stop” button.

### Step 2

The user uploads the recorded audio file from the terminal to the server.

The terminal opens a secure communication channel (for example, HTTPS) to the server, constructs an HTTP POST request with a multipart/form-data body, and attaches the audio file as a binary payload.

Input: digital audio file stored on the terminal.

Output: audio data stored in server-side storage and an audio identifier returned to the terminal.

The server receives the HTTP request, parses the multipart sections, writes the audio binary into a storage device, such as a disk or object store, assigns a unique audio ID (for example, “audio_12345”), and sends a JSON response containing the audio ID back to the terminal.

### Step 3

The server normalizes the uploaded audio data.

The server reads the audio file corresponding to the audio ID from storage, and uses an audio processing library to convert the file into a unified internal format (for example, mono, 16-bit, 16 kHz PCM).

Input: audio data in an arbitrary original format (for example, stereo 44.1 kHz MP3).

Output: normalized audio buffer in the unified internal format.

The server decodes the file, resamples the waveform if necessary, converts stereo to mono by averaging channels, and stores the normalized waveform in a memory buffer for subsequent analysis.

### Step 4

The server extracts acoustic feature quantities and a speaker embedding from the normalized audio.

The server segments the waveform into overlapping frames (for example, 25 ms window, 10 ms hop), applies a windowing function such as a Hamming window, and computes a frequency-domain representation using a fast Fourier transform. The server then computes Mel-frequency cepstral coefficients, log-Mel spectrograms, energy levels, and pitch contours for each frame, and feeds sequences of these features into a pre-trained speaker-embedding neural network to obtain a speaker embedding vector.

Input: normalized audio buffer in the unified internal format.

Output: acoustic feature matrices (for example, MFCCs, Mel-spectrogram) and a fixed-length speaker embedding vector representing the specific person's voice characteristics.

The server stores the resulting acoustic features and speaker embedding in a feature database, indexed by the audio ID and a person label.

### Step 5

The user provides character information representing the specific person's language style via the terminal.

The terminal displays a text input field where the user types or pastes representative sentences, transcripts, or writings that reflect the person's typical expressions and thinking patterns. The terminal encodes the text as UTF-8 and sends it to the server in a JSON body.

Input: raw textual content entered by the user on the terminal.

Output: character information stored in the server's database, linked to the person label.

The server receives the JSON payload, validates that required fields are present (for example, person label and text body), and writes the text into a persistent storage record.

### Step 6

The server performs language analysis processing on the character information and constructs a language feature profile.

The server tokenizes the text into sentences and tokens, applies part-of-speech tagging and dependency parsing using a natural language processing engine, and computes sentence embeddings using a transformer-based encoder. The server then collects statistics on word frequencies, n-gram patterns, sentence length distributions, and syntactic structures, and generates style indices such as formality level and politeness level.

Input: raw character information stored for the specific person.

Output: language feature profile that includes numerical vectors (for example, style embeddings), statistical tables, and symbolic descriptors representing the speaking manner and thinking pattern of the specific person.

The server writes the language feature profile into a profile table in the database, associated with an internal profile ID and the person label.

### Step 7

The user inputs a generation instruction sentence (prompt sentence) on the terminal.

The terminal provides a prompt input screen that includes a text box and a person selector. The user may type a prompt sentence such as:

“In Mr. Tanaka's voice, please say: ‘Good morning, everyone. Thank you for your hard work.’”

“Please generate a short encouragement message in Mr. Tanaka's usual style for a team member who is tired.”

“In Mr. Tanaka's tone, please explain briefly why today's meeting is important.”

The terminal packages the prompt sentence and the person label into a JSON object and transmits it to the server over HTTPS.

Input: prompt sentence and person label entered by the user.

Output: generation request stored or queued on the server for further processing.

The server receives the request, logs the prompt sentence in a request log, and may enqueue the request into a task queue for asynchronous processing.

### Step 8

The server constructs a conditioned prompt for a generative language model based on the prompt sentence and the language feature profile.

The server retrieves the language feature profile associated with the person label, extracts style descriptors and typical phrase patterns, and generates an internal style description string. The server concatenates this style description with the user-provided prompt sentence to form a combined input sequence for the generative AI model.

Input: prompt sentence and corresponding language feature profile.

Output: conditioned prompt text that encodes both the user instruction and the target person's style.

The server may, for example, prepend: “You are speaking as a polite, concise businessperson who often thanks colleagues. Use short, respectful sentences.” to the user's prompt text, and then format the combined string according to the generative model's input specification.

### Step 9

The server generates style-consistent text by executing the generative language model.

The server passes the conditioned prompt to a transformer-based generative AI model that has been trained to predict the next token given previous tokens. The model processes the prompt through multiple self-attention and feedforward layers, computes probability distributions over possible next tokens at each step, and samples or selects tokens according to configured parameters such as temperature and top-k or top-p thresholds.

Input: conditioned prompt text formed in Step 8.

Output: generated text that satisfies the content request of the prompt sentence and conforms to the speaking manner captured in the language feature profile.

The server continues token generation until an end-of-sequence token or a maximum length limit is reached, concatenates the tokens into a string, and then applies post-processing steps such as trimming extraneous explanations, normalizing punctuation, and ensuring that only the desired utterance remains.

### Step 10

The server estimates a user emotional state and computes control parameters for speech generation.

The server receives emotional state indicators from the terminal or a sensing device, such as recent user voice samples, interaction speed, or explicit selections. The server runs emotion-recognition algorithms, such as a classifier based on acoustic features or text sentiment analysis, to categorize the emotional state as, for example, calm, stressed, or sad. Based on this state, the server computes control parameters specifying target intonation range, speaking speed, volume level, and style level adjustments.

Input: signals or data reflecting the user's emotional state.

Output: control parameters for adjusting prosody and style in subsequent speech synthesis and, optionally, text refinement.

The server may then slightly modify the generated text (for example, choosing more supportive phrases) and will definitely pass the control parameters to the speech synthesis stage.

### Step 11

The server synthesizes an audio waveform using the generated text, the acoustic features, and the control parameters.

The server converts the generated text into a sequence of tokens (characters, phonemes, or subword units) suitable for a neural text-to-speech model. The server feeds the text sequence, the speaker embedding vector, prosody statistics from the acoustic feature quantities, and the emotional control parameters into a speech synthesis model such as a Tacotron-type or VITS-type network. The model outputs an acoustic representation such as a Mel-spectrogram. The server then passes this representation to a neural vocoder that generates a time-domain waveform by iteratively refining noise samples or directly mapping spectrogram frames to audio samples.

Input: generated text, speaker embedding vector, acoustic feature quantities, and control parameters.

Output: synthesized audio waveform in a raw PCM buffer representing speech imitating the specific person's voice and speaking manner under the current emotional conditions.

The server encodes the waveform into an audio file format (for example, WAV or compressed format), assigns a file name (for example, “gen_tanaka_001.wav”), and stores it in an output storage area.

### Step 12

The server delivers the generated audio data to the terminal.

The server prepares a response message containing either a direct binary payload of the audio file or a URL from which the terminal can download or stream the file. The server sends this response through the established secure connection.

Input: synthesized audio file and associated metadata stored on the server.

Output: response data including the generated audio content or a reference to it, transmitted to the terminal.

The server may also record logs that link the generation request, the profile IDs, and the output file for future analysis or auditing.

### Step 13

The terminal receives and plays back the generated audio to the user.

The terminal parses the server's response, downloads the audio file if a URL is provided, and stores it in temporary local storage or a memory buffer. The terminal then invokes an audio playback module provided by the operating system, decodes the audio format into PCM samples, and sends the samples to the audio output hardware.

Input: generated audio data or an audio file URL from the server.

Output: audible speech rendered through the terminal's loudspeaker or connected headphones, perceived by the user as the specific person speaking with an appropriate style and emotional nuance.

The user can control playback using on-screen buttons (play, pause, stop), and the terminal can display basic information such as file name or generation time while the audio is played.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional voice synthesis and conversational systems that utilize machine learning models are typically designed to generate generic speech or text responses that do not accurately reflect the speaking style, thinking pattern, or emotional nuance of a specific entity. Even when style conditioning is attempted, existing architectures generally treat style as a static parameter, and do not dynamically adjust voice prosody, speed, or phrasing based on real-time user state or user emotion. As a result, these systems often produce responses that are perceived as monotonous, unnatural, or misaligned with the user's expectations, thereby degrading user experience and limiting the practical applicability of such systems in interactive content delivery and dialog scenarios.

Furthermore, existing pipelines frequently implement text understanding, style adaptation, and voice synthesis as loosely coupled modules without an integrated control mechanism using prompt sentences for a generative AI model. In such configurations, a text generation engine may operate independently of a voice synthesis engine, leading to inefficiencies such as repeated style conversion, redundant processing, increased latency, and suboptimal utilization of computing resources. These inefficiencies are particularly problematic in server-based architectures that must serve a large number of concurrent users and maintain low response times.

In addition, conventional systems typically do not leverage explicit prompt construction and prompt updating to encode user-selected voice types, specific entity characteristics, and user emotion into a unified control interface to a generative AI model. Without such prompt-driven coordination, the system cannot stably and reproducibly generate text and audio content that jointly reflect a coherent persona and adapt in real time to user behavior or emotional state. This lack of an integrated, prompt-centric control layer prevents meaningful improvements to the underlying computer technology, such as structured management of model inputs, efficient reuse of style representations, and reduction of processing complexity across the text and audio generation pipeline.

Accordingly, there is a need for a computer-implemented system that (i) transforms input audio information into symbolic information in a form suitable for downstream processing, (ii) generates and applies structured prompt sentences for a generative AI model to obtain text that imitates the speaking style and thinking pattern of a specific entity, (iii) synthesizes corresponding audio information using an acoustic generation mechanism, and (iv) dynamically adjusts voice prosody, speed, and speaking style in response to user emotion, in an integrated manner. Such a system should improve the operation of computers by providing an efficient, prompt-driven control architecture that coordinates text generation and voice synthesis, reduces redundant processing, and enhances responsiveness and personalization of audio output.

The specific processing by the specific processing unit 290 of the data processing device 12 in Application Example 1 is realized by the following means.

The present invention provides a server comprising a processor configured to receive audio information as input, analyze signal information of the audio information by using acoustic processing technology, extract feature information from the signal information, convert the feature information into symbolic information, receive character information as input, generate a prompt sentence that instructs a generative AI model to imitate a speaking style and a thinking pattern of a specific entity, input the prompt sentence into the generative AI model, generate character information of an imitation speaking style, input the character information of the imitation speaking style, based on the character information and a voice type selected by a user, into a voice processing mechanism that uses acoustic generation technology, synthesize audio information that imitates an audio feature of the specific entity, encode the audio information into distribution information, transmit the distribution information to a utilization terminal, estimate an emotional state of the user based on instruction information from the user and the character information of the imitation speaking style, generate a further prompt sentence that instructs adjustment of prosody, speed, and speaking style of a voice of the specific entity in accordance with the emotional state, and apply the further prompt sentence to the generative AI model and the voice processing mechanism. This enables an integrated and computer-implemented processing pipeline in which audio information is converted into symbolic information, prompt-controlled generative text is produced to mimic a specific entity, and emotion-adaptive voice synthesis is executed under unified prompt control, thereby improving computational efficiency, reducing processing latency, and enhancing the personalization and naturalness of system-generated audio output.

The term “audio information” refers to information representing sound in an analog or digital form, including but not limited to sampled waveforms, encoded audio streams, or any other machine-processable representation of sound signals.

The term “signal information” refers to data obtained from audio information by signal processing, including time-domain or frequency-domain representations, such as sample sequences, spectra, or other mathematically transformed forms used for analysis.

The term “acoustic processing technology” refers to hardware, software, or a combination thereof that performs signal processing operations on audio information, such as filtering, feature extraction, time-frequency analysis, or conversion to intermediate representations used for subsequent processing.

The term “feature information” refers to data representing characteristic properties of audio information, including but not limited to spectral features, prosodic features, phonetic features, or any other descriptors extracted for recognition, analysis, or synthesis.

The term “symbolic information” refers to information expressed in a symbolic format, such as characters, phonetic symbols, tokens, or labels, which can be processed as discrete units by text-processing or language-processing components.

The term “character information” refers to information expressed as strings or sequences of characters, including natural language text, control tokens, markup tags, or other textual data used as input to or output from a language model.

The term “generative AI model” refers to a machine-implemented model that generates output data, such as text, audio, or other content, based on input data, the model being trained using data-driven methods such as machine learning or deep learning.

The term “prompt sentence” refers to character information that specifies instructions, conditions, or context for operation of a generative AI model, and that controls the style, content, or behavior of output generated by the generative AI model.

The term “specific entity” refers to a target persona, such as a particular individual, character, or archetype, whose speaking style, thinking pattern, or vocal characteristics are to be imitated by the system.

The term “speaking style” refers to a manner of speaking of a specific entity, including but not limited to lexical choice, sentence structure, rhythm, register, and typical expressions reflected in generated text or speech.

The term “thinking pattern” refers to a characteristic way of reasoning, explaining, or structuring information associated with a specific entity, which can be emulated by generated text to resemble that entity's manner of thought.

The term “imitation speaking style” refers to a speaking style generated by the system that is intended to resemble the speaking style of a specific entity, as produced by processing using a generative AI model and associated control information.

The term “voice type” refers to a classification or identifier of a desired vocal profile, including characteristics such as pitch range, timbre, gender, age group, or association with a specific entity, selected by a user.

The term “voice processing mechanism” refers to hardware, software, or a combination thereof that converts character information into audio information, including text-to-speech engines, acoustic models, vocoders, or similar components.

The term “acoustic generation technology” refers to techniques and systems that synthesize audio information from non-audio inputs, such as text or acoustic features, using methods including rule-based synthesis, statistical modeling, or neural network-based synthesis.

The term “audio feature” refers to a characteristic attribute of a voice signal, including but not limited to timbre, pitch contour, rhythm, or other measurable qualities that distinguish the voice of a specific entity.

The term “distribution information” refers to audio information that has been encoded, packaged, or formatted for transmission, storage, or streaming, including metadata, container formats, and encoded bitstreams.

The term “utilization terminal” refers to an information processing apparatus operated by a user, such as a mobile terminal, personal computer, or other client device, that receives and reproduces distribution information.

The term “instruction information” refers to information provided by a user to the system, including commands, selections, text inputs, or control signals that specify desired operations, configurations, or content.

The term “emotional state” refers to an inferred or estimated affective condition of a user, such as happiness, sadness, anger, or calmness, determined based on instruction information, interaction history, or other detectable indicators.

The term “prosody” refers to suprasegmental characteristics of speech, including intonation, stress, rhythm, and phrasing, which influence how speech sounds natural or expressive.

The term “processor” refers to one or more hardware processing units, such as a central processing unit, graphics processing unit, or specialized accelerator, and associated control logic configured to execute instructions for implementing functions of the system.

In one embodiment, a server implements the claimed system as a network-accessible service executed on one or more physical machines. The server includes at least one central processing unit (CPU), such as a multi-core x86-compatible processor, one or more graphics processing units (GPUs) that support parallel floating-point computation, such as a general-purpose GPU, a main memory, a non-volatile storage device such as a solid-state drive (SSD), a network interface controller, and an audio interface for test playback. The server executes an operating system such as a Unix-like operating system and middleware including a web server, an application server, and a database management system.

The server stores and executes an application program implemented, for example, using a server-side framework. The application program is configured to control a generative AI model and an acoustic generation stack including a neural text-to-speech (TTS) model and a neural vocoder. In one configuration, the server employs a transformer-based language model comparable in architecture to a large-scale generative AI model (for example, a multi-layer transformer decoder with self-attention) and an acoustic model comparable in architecture to Tacotron 2 (sequence-to-sequence model with attention for converting text into mel-spectrograms) and a neural vocoder comparable in architecture to a flow-based or generative adversarial network (GAN) vocoder, such as a model that converts mel-spectrograms into time-domain waveforms.

The terminal operates as a client device such as a smartphone, tablet, or personal computer. The terminal includes a CPU, a memory, a display unit, an audio output device, and a network interface. The terminal executes a client application or web browser. The terminal sends request messages to the server and receives distribution information including synthesized audio. The terminal decodes the distribution information and reproduces sound through the audio output device. The user operates the terminal to select a voice type, input character information, and control playback.

The user interacts with a graphical user interface presented on the terminal. The terminal displays controls for selection of a voice type, including different specific entities such as different personas or archetypes, and text input fields for character information. The user may paste text of a narrative, enter a question, or select pre-defined content. The terminal records user selections, including the voice type identifier, language preference, and optional emotion preference, and transmits these as instruction information to the server.

The server stores audio information and character information in defined data structures. Audio information is represented internally as arrays of 16-bit or 32-bit linear pulse-code modulation (PCM) samples, or as compressed frame sequences in formats such as an audio codec format. Signal information is derived from audio information by applying short-time Fourier transform (STFT) operations, windowing, and spectral analysis. The server represents signal information as complex spectra indexed by time frame and frequency bin. Feature information includes mel-spectrogram vectors of fixed dimension per frame, prosodic descriptors such as pitch contours (fundamental frequency F0 sequences), energy envelopes, and duration statistics. Symbolic information includes time-aligned phoneme sequences, subword tokens, and punctuation tags.

The server implements acoustic processing technology using digital signal processing libraries. The server converts input audio information into feature information by applying pre-emphasis, framing, windowing, fast Fourier transform, mel-filterbank integration, and logarithmic scaling. The server may also apply voice activity detection to remove silence segments and normalize loudness. This conversion into mel-spectrograms and prosodic features allows the server to separate content-related and style-related characteristics, which is important for accurate imitation of an audio feature of a specific entity.

The server uses the generative AI model to generate character information of an imitation speaking style. The server stores the generative AI model as a set of learned parameters representing multiple transformer layers, including attention weight matrices and feed-forward network weights. The model is trained offline using a corpus of text associated with multiple entities. During training, the server tokenizes training text into subword units, encodes entity identifiers, and optimizes model parameters by minimizing a negative log-likelihood loss function using stochastic gradient descent or a variant such as Adam. The server may perform data augmentation by paraphrasing sentences or augmenting with additional descriptive information to improve robustness.

At inference time, the server receives character information and a selected voice type from the terminal. The server constructs a prompt sentence as a control input to the generative AI model. The prompt sentence combines (i) system-level instructions describing a speaking style and thinking pattern of a specific entity, (ii) a request context indicating whether the purpose is narration or dialog, and (iii) the user-supplied text. By structuring the prompt sentence in this way, the server causes the generative AI model to generate output that is consistent in persona across multiple turns, which is not achievable by a simple template substitution or isolated rule-based processing.

In one example, the server generates a prompt sentence for narration as follows:

“Act as [Voice Actor A]. Rewrite the following text as if you are narrating it for an audiobook. Preserve the meaning, but use natural, expressive spoken language and phrasing typical of [Voice Actor A].

Text:

‘The story begins here . . . ’”

In another example, the server generates an interactive prompt sentence for dialog as follows: “You are [Voice Actor A]. Reply to the user's message in the tone, rhythm, and vocabulary typical of [Voice Actor A], and make the explanation easy to understand.

User message: ‘Please explain how this system works.’”

The server inputs such prompt sentences to the generative AI model by encoding the prompt into token identifiers, feeding the token sequence into the transformer network, and computing attention-based context vectors across layers. The server uses nucleus sampling or beam search to generate output tokens. The generative AI model performs computation that humans do not perform manually, such as multi-head self-attention over thousands of tokens and large-dimensional matrix multiplications, thereby enabling consistent and fast persona-conditioned text generation that would be practically infeasible by human effort or simple automation.

The server estimates an emotional state of the user based on instruction information and character information of the imitation speaking style. The server may store a separate emotion estimation model implemented as a neural classifier or sequence model. The server encodes recent user inputs, including lexical cues (“I am sad,” “That is amazing”), punctuation, and usage of emotive phrases, into fixed-length embeddings. The server feeds these embeddings into a recurrent neural network or transformer encoder, which outputs a probability distribution over emotion labels such as “joy,” “sadness,” “anger,” and “neutral.” Alternatively, the server extracts prosodic features from audio information provided by the user and uses a classifier trained to map pitch variance, speech rate, and energy patterns to emotion labels. The server then determines the emotional state as the label with the highest probability or as a weighted combination.

The server uses the emotional state to construct a further prompt sentence and to modify acoustic parameters. For the prompt sentence, the server appends explicit instructions for adjusting style, such as “speak more calmly and slowly” or “use brighter, more energetic expressions,” in accordance with the emotional state. The server thus alters the generative AI model's output distribution in a controlled manner, creating text that is contextually aligned with the user's mood. For acoustic parameters, the server sets target prosody control values, such as pitch shift, speaking rate modification factor, and pause insertion thresholds, which are passed to the voice processing mechanism.

The server implements the voice processing mechanism using a neural text-to-mel model and a neural vocoder. The server encodes character information of the imitation speaking style as sequences of phonemes or graphemes, normalizes numerals and abbreviations, and applies punctuation-based phrase segmentation. The server feeds these sequences into an encoder network, such as a stack of convolutional or recurrent layers, to obtain latent representations. An attention-based decoder iteratively generates mel-spectrogram frames, conditioned on the latent representation and on a speaker embedding corresponding to the selected voice type. The speaker embedding is a trainable vector representing an audio feature of a specific entity, learned during multi-speaker training. The server modifies the decoder input by adding prosody control signals derived from the estimated emotional state, such as scaling duration predictions or adjusting pitch contours.

The server then passes the mel-spectrogram frames to a neural vocoder. The neural vocoder may be a flow-based model or a GAN-based model that transforms mel-spectrograms into PCM samples. The server executes multi-stage convolutional upsampling and non-linear activations on the GPU to generate time-domain waveforms at a specified sampling rate. By using a learned mapping, the neural vocoder can synthesize high-fidelity speech that closely matches the timbre and style of the specific entity. The server can pre-load model weights into GPU memory and batch process multiple requests, thereby reducing per-request latency and improving throughput.

The server encodes the synthesized audio information into distribution information. The server uses an audio codec library such as a widely used media processing library to convert raw PCM samples into compressed audio streams. The server embeds metadata including sampling rate, channel count, duration, and identifier of the voice type. The server stores the distribution information temporarily in an object store or transmits it directly to the terminal using a streaming protocol such as HTTP Live Streaming or a direct HTTP response with appropriate headers. By aligning the data structures and wire formats, the server reduces parsing overhead and achieves stable low-latency delivery.

The terminal receives the distribution information and decodes the compressed audio using a platform multimedia framework. The terminal writes decoded PCM samples into an audio buffer and configures the audio output device for playback. The user listens to the synthesized voice that imitates the specific entity. The user may adjust playback speed, re-request different emotional tones, or select a different voice type, in which case the terminal sends new instruction information to the server and the process is repeated.

This architecture provides technical improvements beyond mere automation of human tasks. By using a prompt sentence as a unified control interface to the generative AI model, the server can represent, in a structured way, the combination of persona attributes, dialog context, and user emotion that would otherwise require ad hoc parameter settings scattered across modules. The server's prompt construction and update mechanism reduces the number of separate control channels, simplifies the configuration space, and allows the generative AI model to share computation across multiple conditions, improving computational efficiency.

Moreover, the server's design reduces redundant style transformations. Instead of first generating neutral text and then applying separate linguistic rules to approximate the specific entity's style, the server directly generates style-adapted text using the generative AI model conditioned by the prompt sentence. This lowers the number of processing stages, reduces memory transfers between modules, and eliminates certain post-processing passes, thereby decreasing latency and CPU usage. The server also stores pre-computed speaker embeddings and prosody templates for each voice type, which allows reuse of learned style parameters across sessions and reduces the amount of per-request computation.

The server's combination of emotion estimation with prosody control and prompt-based text adaptation yields a technical effect on the quality and stability of the generated audio. By mapping emotion labels to both text-level and audio-level control parameters, the server can maintain coherence between what is said and how it sounds. This reduces artifacts such as mismatched intonation or inconsistent emotional cues, which can arise when text and audio are generated independently. The reduction of such artifacts is measurable as a decrease in reconstruction error of prosodic features and as an increase in perceptual naturalness ratings in user studies.

From a training perspective, the server prepares the generative AI model and the acoustic models using supervised learning and, optionally, fine-tuning with reinforcement signals. The server defines a loss function that includes a cross-entropy term for token prediction, a mean-squared error term for mel-spectrogram reconstruction, and additional regularization terms for attention alignment and speaker separation. During training, the server computes gradients of the loss with respect to model parameters using backpropagation and updates the parameters using an optimizer such as Adam with decoupled weight decay. The server may augment training data by noise injection, pitch shifting, and time-stretching of audio, as well as paraphrasing or shuffling of text segments, to increase robustness. These training steps are performed using GPU parallelism and mini-batch processing to improve convergence speed and model performance.

In alternative embodiments, the server may implement different neural network architectures, such as conformer-based encoders for better modeling of local and global dependencies, or diffusion-based vocoders for improved audio fidelity. The server may also employ different tokenization schemes, such as byte-pair encoding, unigram language models, or character-level encoding, depending on the language and domain. The voice processing mechanism may be implemented with a non-autoregressive TTS model to further reduce latency by generating all mel-spectrogram frames in parallel, combined with a duration predictor for alignment.

In another embodiment, the server can store multiple generative AI models specialized for different domains (for example, narrative, technical explanation, conversation) and select an appropriate model based on instruction information or content type. The server may also dynamically adjust model parameters such as temperature, repetition penalty, and maximum output length based on user preferences or latency requirements. These variations allow the server to balance naturalness, responsiveness, and resource consumption in different deployment environments.

By integrating these hardware and software components, and by orchestrating them through structured prompt sentences and emotion-aware control, the server improves the operation of the underlying computer system. The system reduces the number of data passes, optimizes parallel execution on GPUs, and structures control signals in a way that allows automatic caching and reuse of intermediate representations. As a result, the server achieves improved processing speed, reduced computational load per request, improved accuracy in style and emotion imitation, and enhanced consistency of generated audio output, which collectively constitute technical improvements to computer technology rather than a mere implementation of an abstract idea.

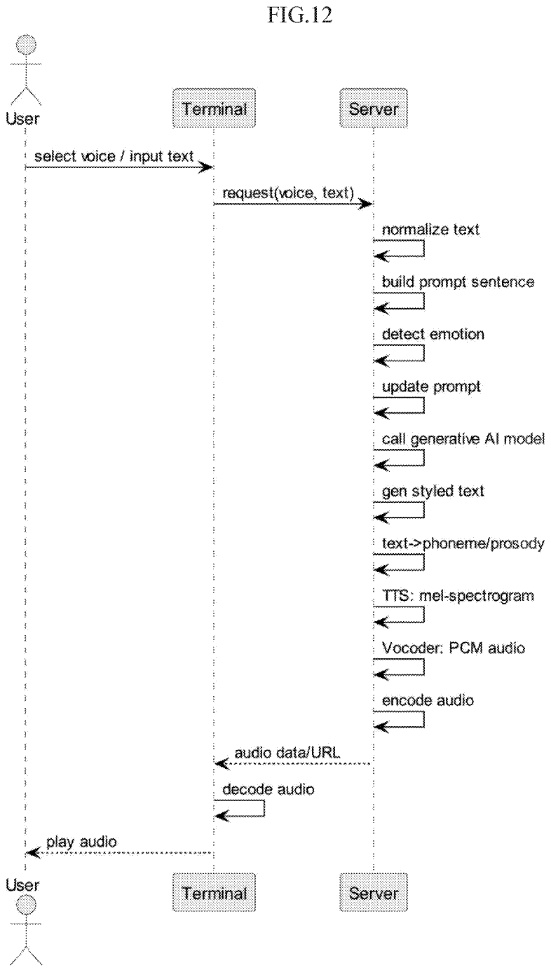

The following describes the processing flow using FIG. 12.

### Step 1

The user operates the terminal to select a voice type and input text. The terminal receives, as input, user interaction events such as touch operations, keyboard entries, and menu selections, and outputs a structured request object including a user identifier, a selected voice type identifier, and character information. The terminal converts GUI inputs into internal data structures, validates that required fields are present, and packages the data into a request message for transmission.

### Step 2

The terminal transmits the request message to the server. The terminal uses a communication library to send, as input to a network stack, the structured request object and a destination address, and outputs an encoded network packet (for example, an HTTPS POST request) containing the user identifier, the selected voice type identifier, and the character information. The terminal performs serialization of the data into a text-based format, sets HTTP headers, and writes the serialized bytes to a transmission buffer.

### Step 3

The server receives and parses the request message. The server accepts, as input, the network packet from the terminal and outputs an internal representation of the request including parsed fields. The server decodes the packet at the transport and application layers, verifies message integrity, parses the serialized data, and stores the user identifier, voice type identifier, and character information into memory. The server also logs metadata such as timestamp and request size into a logging subsystem.

### Step 4

The server normalizes the character information. The server receives, as input, the raw character information from the parsed request and outputs normalized character information suitable for further processing. The server performs data processing including Unicode normalization, removal or replacement of unsupported characters, expansion of numerals and abbreviations into full words, and segmentation of text into sentences or utterances. The server updates internal data structures to store token boundaries and sentence indices.

### Step 5

The server constructs a base prompt sentence for the generative AI model. The server uses, as input, the normalized character information, the selected voice type identifier, and stored style descriptors of a specific entity, and outputs a base prompt sentence in natural language. The server concatenates template strings, style descriptions, and the normalized character information, and inserts markers indicating whether the request is for narration or dialog. The server thereby generates a text instruction that encodes desired speaking style and thinking pattern.

### Step 6

The server estimates an emotional state of the user. The server receives, as input, recent instruction information from the user, such as prior messages, selected emotion settings, or prosodic features of user-provided audio, and outputs an emotion label and associated confidence scores. The server converts textual cues into embeddings, applies a trained neural classifier or sequence model, and computes probabilities for predefined emotion categories. The server selects the dominant emotion label or forms a weighted combination and stores the emotion representation as part of the session context.

### Step 7

The server augments the base prompt sentence using the emotional state. The server takes, as input, the base prompt sentence and the emotion label and outputs an emotion-aware prompt sentence. The server appends or inserts phrases that instruct the generative AI model to adjust tone, energy, and politeness according to the detected emotion, and may modify constraints on speaking speed and expressiveness. The server updates the text string of the prompt so that it simultaneously encodes persona and emotion control.

### Step 8

The server tokenizes the emotion-aware prompt sentence and calls the generative AI model. The server uses, as input, the emotion-aware prompt sentence and model configuration parameters such as maximum length and sampling strategy, and outputs a sequence of token identifiers to be processed by the generative AI model. The server converts characters into subword tokens using a tokenizer, maps tokens to numerical IDs, forms an input tensor, and sends this tensor to a model execution engine on a GPU. The server configures the engine with the selected generative AI model and forwards the tensor for inference.

### Step 9

The server executes the generative AI model to generate imitation speaking style text. The server receives, as input, the tokenized prompt tensor and outputs a sequence of output tokens representing character information of an imitation speaking style. The server performs multi-layer transformer computations, including self-attention operations, feed-forward network activations, and normalization over each layer, to compute probability distributions over the vocabulary. The server samples or decodes tokens based on these distributions and accumulates generated tokens until a termination condition is met. The server then converts the token sequence back into character information.

### Step 10

The server post-processes the imitation speaking style text. The server uses, as input, the raw generated character information from the generative AI model and outputs cleaned and segmented imitation speaking style text. The server removes control tokens or extraneous markers, trims whitespace, normalizes punctuation, and enforces sentence boundary rules. The server may also segment the text into utterance units optimized for speech synthesis, and stores these segments in a data structure that preserves order and timing hints.

### Step 11

The server converts the imitation speaking style text into phoneme and prosody sequences. The server accepts, as input, the cleaned imitation speaking style text segments and outputs phoneme sequences and prosody control parameters. The server applies text normalization suitable for speech synthesis, uses a grapheme-to-phoneme converter to map words to phonemes, and assigns baseline durations and stress patterns. The server then modifies these prosodic values based on the detected emotional state, adjusting speaking rate, pitch contours, and pause positions according to predefined mappings.

### Step 12

The server synthesizes mel-spectrograms using a neural text-to-speech model. The server uses, as input, the phoneme sequences, prosody parameters, and a speaker embedding associated with the selected voice type, and outputs mel-spectrogram frames representing audio features of the specific entity. The server feeds the phoneme and prosody representations to an encoder, passes the encoder outputs and speaker embedding to an attention-based decoder, and iteratively computes mel-spectrogram frames. The server accumulates the frames into a time-ordered matrix for each text segment.

### Step 13

The server converts mel-spectrograms into PCM audio using a neural vocoder. The server takes, as input, the mel-spectrogram matrices and outputs sequences of PCM samples representing synthesized speech waveforms. The server executes a vocoder network that upsamples the mel-spectrograms through convolutional and non-linear layers, generating time-domain samples at the target sampling rate. The server concatenates PCM sequences corresponding to individual segments, aligns boundaries, and applies optional post-processing such as de-noising or normalization.

### Step 14

The server encodes the PCM audio into distribution information. The server receives, as input, the concatenated PCM sample sequence and metadata such as sampling rate, bit depth, and voice type identifier, and outputs encoded audio data in a transmission format. The server invokes an audio codec to compress the PCM samples into a bitstream (for example, a compressed audio format), constructs a container with headers and metadata, and stores or streams this container as distribution information. The server updates indexing data to support seeking and partial playback.

### Step 15

The server transmits the distribution information to the terminal. The server uses, as input, the encoded audio container and connection information for the terminal, and outputs a network response containing the distribution information. The server prepares HTTP response headers appropriate for audio content, writes the encoded data into the response body or into a streaming segment, and sends the response through the network stack. The server may also generate a resource locator and include it in a control message so that the terminal can request additional segments.

### Step 16

The terminal receives and decodes the distribution information. The terminal accepts, as input, the network response from the server containing the encoded audio data and outputs decoded PCM samples for playback. The terminal reads the response stream, parses headers, and feeds the encoded payload into a decoder module of a multimedia framework. The decoder reconstructs PCM samples from the bitstream and writes them into an audio buffer managed by the operating system or client application.

### Step 17

The terminal outputs the synthesized voice to the user. The terminal uses, as input, the decoded PCM samples and playback control commands from the user, and outputs analog audio signals through speakers or headphones. The terminal configures audio output parameters such as volume and channel balance, schedules buffer playback using the system audio mixer, and continuously writes samples to the hardware audio device. The user listens to content spoken in the imitation speaking style corresponding to the selected voice type and the estimated emotional state.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialogue systems and content generation systems based on generative AI models are typically designed as general-purpose language generation tools that do not accurately capture or reproduce the expression style and thinking style of a particular subject. In many implementations, text data related to a particular subject is merely used as training material without a structured pipeline for data acquisition, preprocessing, model conditioning, and multi-modal (text and audio) output generation. As a result, these systems often exhibit the following technical problems from the standpoint of computer technology.

First, conventional systems do not provide an integrated mechanism in which a processor automatically acquires record data and communication history concerning a particular subject from a communication network, preprocesses the acquired data into a uniform, machine-readable data structure using data processing software and natural language processing software, and then uses the preprocessed data to configure a generative AI model. This lack of an integrated pipeline leads to fragmented workflows, inconsistent data representations, and inefficient use of computing resources, thereby degrading the reproducibility and controllability of the model behavior at inference time.

Second, conventional systems generally do not distinguish between different categories of character-based data, such as direct records of the subject's own utterances and writings versus third-party explanation data describing the subject. As a result, feature values indicating vocabulary tendencies, writing style tendencies, and thinking tendencies of the specific subject are not explicitly extracted and are not used as condition information within the generative AI model. This absence of explicit feature extraction and conditioning makes it difficult for the model to accurately emulate the nuanced expression style and thinking style of the subject within a constrained computational environment.

Third, typical systems handle prompts from users as simple textual instructions without integrating them with structured condition information that encodes the subject's style, and without dynamically adapting such condition information based on user emotional state. Consequently, the model input at inference time is not optimized for style-consistent, context-aware generation, which leads to outputs that are either generic or unstable in style, and fails to exploit the full capabilities of the underlying machine learning architecture.

Fourth, most existing architectures treat text generation and audio synthesis as separate processes, without a unified control layer in the processor that coordinates the generative AI model and an acoustic data synthesis technique using common condition information. In particular, prosodic characteristics and speech style of the subject's voice are not systematically parameterized and linked to both the generated text and the synthesized audio. This separation results in a mismatch between textual style and vocal characteristics, inefficient resource usage, and more complex integration logic at the application layer.

Accordingly, there is a need for an improved computer-implemented system and processing architecture in which a processor: (i) automatically acquires and preprocesses subject-related character-based data into a training-ready representation; (ii) configures a generative AI model with explicit feature values corresponding to the subject's style; (iii) generates structured model input information by integrating user prompt sentences with style-related condition information; (iv) recognizes a user's emotional state and adaptively adjusts style-related condition information; and (v) coordinates text generation and acoustic data synthesis in a unified manner. Such an improved architecture would enhance the accuracy, stability, and controllability of persona-specific dialogue reproduction, while also improving computational efficiency and reusability of models and data structures.

The specific processing by the specific processing unit 290 of the data processing device 12 in Example 2 is realized by the following means.

The present invention provides a server comprising a processor, wherein the processor is configured to receive acoustic data as input, analyze an acoustic signal by using an acoustic information processing technique, extract acoustic features from the acoustic signal, and convert the acoustic features into character-based data; to receive character-based data as input, acquire record data and communication history concerning a specific subject from a communication network by using an information acquisition function, and perform preprocessing on the acquired data by using data processing software and natural language processing software to execute removal of unnecessary information, normalization of character strings, and segmentation into unit elements so as to convert the acquired data into an analyzable data structure suitable for training or adjustment of a generative AI model; to receive the preprocessed character-based data as input, train or adjust the generative AI model including a machine learning model and construct the generative AI model so as to imitate an expression style and a thinking style of the specific subject; to receive a prompt sentence including instruction content from a user as input, generate model input information by integrating the prompt sentence with condition information indicating the expression style and the thinking style of the specific subject, and instruct the generative AI model to generate a text response based on the model input information; to recognize an emotional state of the user, generate a prompt sentence including condition information indicating prosodic characteristics and speech style of a voice of the specific subject according to the emotional state, and instruct the generative AI model and an acoustic data synthesis technique to perform response generation and acoustic data synthesis based on the condition information; and to input character-based output data from the generative AI model to the acoustic data synthesis technique, generate acoustic data imitating voice characteristics and speech style of the specific subject, and provide the character-based output data and the acoustic data to an output device. This enables an integrated, computer-implemented pipeline in which subject-related character-based data is automatically acquired and normalized into a training-ready structure, explicit style features of the specific subject are encoded as condition information for a generative AI model, user prompt sentences are systematically combined with such condition information and with user emotional state to form optimized model input, and text generation and audio synthesis are jointly controlled by the processor, thereby improving the accuracy, consistency, and efficiency of persona-specific dialogue reproduction in a computing environment.

The term “acoustic data” refers to digital information representing sound signals, including but not limited to voice signals, environmental sounds, and other audio waveforms, which are processable by a computing device.

The term “acoustic signal” refers to an analog or digital representation of sound energy over time, which can be analyzed to extract features such as pitch, intensity, timbre, and temporal patterns.

The term “acoustic features” refers to numerical or symbolic descriptors derived from an acoustic signal, including but not limited to spectral coefficients, pitch contours, energy levels, and temporal statistics, which characterize properties of the sound.

The term “acoustic information processing technique” refers to hardware, software, or a combination thereof configured to analyze acoustic data, extract acoustic features, and optionally transform or recognize content in the acoustic data.

The term “character-based data” refers to data expressed in a textual format, including sequences of characters, tokens, or symbols, which can be processed by text-handling components of a computing system.

The term “character-based output data” refers to text generated by a generative AI model, including sentences, phrases, or other textual sequences that represent the model's response or output.

The term “character strings” refers to ordered sequences of characters from a character set, such as letters, numerals, punctuation marks, or symbols, which can be manipulated by text processing software.

The term “communication network” refers to any wired or wireless infrastructure that enables data transmission between computing devices, including local area networks, wide area networks, and public networks such as the Internet.

The term “record data” refers to stored information that captures past events, behaviors, or content associated with a specific subject, including logs, documents, messages, and other persistent data items.

The term “communication history” refers to stored data representing past exchanges of messages or content over a communication network, including conversations, posts, comments, and other interactive records.

The term “specific subject” refers to an individual entity, such as a person, persona, or character, whose expression style and thinking style are to be imitated by the generative AI model.

The term “information acquisition function” refers to a software-implemented or hardware-implemented mechanism that retrieves data from local or remote sources, including web pages, databases, and network services.

The term “data processing software” refers to a software component or library configured to load, transform, filter, and restructure data, including operations such as cleaning, aggregation, and formatting.

The term “natural language processing software” refers to a software component or library configured to analyze and manipulate text, including tokenization, part-of-speech tagging, syntactic parsing, and semantic analysis.

The term “preprocessing” refers to a set of operations performed on raw data to transform the raw data into a normalized, structured, and machine-readable format suitable for analysis, training, or inference.

The term “removal of unnecessary information” refers to an operation that deletes or filters out elements such as markup tags, URLs, control characters, or other data that are not required for model training or inference.

The term “normalization of character strings” refers to an operation that converts character strings into a standardized representation, including case conversion, Unicode normalization, and unification of formatting variants.

The term “segmentation into unit elements” refers to an operation that divides character-based data into smaller units, such as sentences, words, or tokens, which serve as basic elements for analysis or model input.

The term “unit elements” refers to minimal text units, including sentences, words, subwords, or tokens, that are used as atomic elements in language processing and model training.

The term “data structure” refers to an organized representation of data, such as arrays, tables, records, or objects, that defines how data elements are stored and related in memory or storage.

The term “analyzable data structure” refers to a data structure formatted so that it can be directly consumed by data analysis or machine learning components without additional structural conversion.

The term “machine learning model” refers to a computational model whose parameters are adjusted based on training data, including neural networks, probabilistic models, and other statistical learning architectures.

The term “generative AI model” refers to a machine learning model configured to generate new data instances, such as text or audio, in response to input data, and to approximate distributions observed in training data.

The term “train or adjust” refers to operations that modify parameters of a machine learning model, including initial training, fine-tuning, or adaptation using additional data to change model behavior.

The term “expression style” refers to characteristic patterns in how a specific subject uses language, including vocabulary choices, sentence structure, tone, and rhetorical devices.

The term “thinking style” refers to characteristic patterns in how a specific subject organizes, reasons about, and presents ideas, including preferred argument structures, perspectives, and logical flows.

The term “prompt sentence” refers to a text-based instruction or query provided by a user, which specifies how the generative AI model should respond or what type of content should be generated.

The term “model input information” refers to structured data provided to a generative AI model at inference time, including prompt sentences, condition information, and optionally context information.

The term “condition information” refers to auxiliary data that constrains or guides the behavior of a generative AI model, including indicators of style, persona, emotional tone, or other control attributes.

The term “text response” refers to character-based output generated by a generative AI model in reaction to model input information, including answers, continuations, or reformulations of text.

The term “user” refers to a human operator or entity that interacts with the system, provides input such as prompt sentences or speech, and receives generated output.

The term “emotional state” refers to an estimated affective condition of a user, such as happiness, sadness, anger, or calmness, derived from signals including text, voice, or other interaction data.

The term “prosodic characteristics” refers to properties of speech such as intonation, rhythm, stress, and timing, which affect how spoken content is perceived.

The term “speech style” refers to characteristic patterns in spoken communication, including typical speed, pauses, emphasis, and phrasing used by a specific subject.

The term “acoustic data synthesis technique” refers to hardware, software, or a combination thereof configured to generate acoustic data, such as text-to-speech synthesis systems and voice conversion systems.

The term “response generation” refers to the process by which a generative AI model produces output content, such as text, in response to given input conditions and prompt sentences.

The term “acoustic data synthesis” refers to the process of generating audio signals, including speech waveforms, from non-audio inputs such as text or control parameters.

The term “voice characteristics” refers to properties that distinguish one voice from another, including timbre, pitch range, formant structure, and other speaker-specific attributes.

The term “output device” refers to a hardware component or system that presents generated content to a user, including displays, speakers, headphones, or combinations thereof.

The term “server” refers to a computing apparatus, which may be implemented by one or more physical or virtual machines, that executes the processor functions described in the system.

In one embodiment, a server, a terminal, and a user cooperate to implement the system for generating text and audio outputs that imitate an expression style and a thinking style of a specific subject. The server includes at least one processor, a memory, a non-transitory storage device, and a network interface. The terminal includes at least one processor, a display, an input device, an audio input device such as a microphone, and an audio output device such as a speaker or headphones. The server and the terminal are connected via a communication network such as the Internet using standard protocols such as HTTPS.

The server uses general-purpose computing hardware, for example, a multi-core central processing unit (CPU) and one or more graphics processing units (GPUs) such as a general-purpose GPU. The server executes an operating system such as a general-purpose server operating system and runs software components that implement data acquisition, data preprocessing, model training, model inference, and audio processing. The server uses data processing software and natural language processing software, such as a table-processing library and a natural language toolkit, to manipulate character-based data. The server also uses a machine learning framework such as a tensor-based computation framework and an audio processing library or service such as a speech recognition engine and a text-to-speech synthesis engine.

The terminal executes a client application, for example, a web browser or a native application, that presents a graphical user interface. The terminal displays input fields that allow the user to enter a target subject identifier and one or more prompt sentences, and also provides controls to start and stop voice input. The terminal acquires audio signals from the microphone, converts the audio signals into digital acoustic data, and transmits the acoustic data and character-based user input to the server.

The server receives acoustic data from the terminal and performs acoustic information processing. The server uses an acoustic information processing technique such as an automatic speech recognition engine (for example, an end-to-end speech recognition model like a sequence-to-sequence model) to analyze the acoustic signal, extract acoustic features such as mel-frequency cepstral coefficients, pitch, and energy, and convert the acoustic features into character-based data representing a transcription of the user's speech. The server stores both the raw acoustic data and the derived character-based data in storage in association with timestamps and session identifiers. By extracting and storing structured acoustic features, the server enables later processing modules to reason about prosodic patterns and emotional cues in a machine-readable form, thereby improving robustness and accuracy of downstream style conditioning.

The server receives character-based data as input from the terminal and from memory. The server acquires record data and communication history concerning a specific subject from one or more data sources. The server uses an information acquisition function implemented by scripts or services that send HTTP requests or call remote APIs to retrieve web pages, online posts, comments, and other subject-related content. The server stores the retrieved raw data, including markup, metadata, and text, into a raw-data data structure such as a table or a document store.

The server performs preprocessing on the acquired data by using data processing software and natural language processing software. The server loads the raw data into memory as data frames or structured objects. The server executes removal of unnecessary information, including HTML tags, scripts, URLs, and extraneous punctuation, using pattern matching and parsing techniques. The server performs normalization of character strings, including case folding, standardization of Unicode characters, conversion between full-width and half-width characters where appropriate, and unification of line-break and space characters. The server divides the normalized text into unit elements by executing segmentation into sentences, words, or sub-word tokens using language-dependent tokenization algorithms. The server stores the resulting unit elements into an analyzable data structure, for example, as records each containing a subject identifier, an original text segment, and a sequence of tokens. By normalizing and segmenting the data into unit elements, the server produces a representation that reduces noise and dimensionality, leading to more stable and efficient training of the generative AI model.

The server distinguishes different categories of character-based data. The server treats certain character-based data as direct record data or communication history of the specific subject, such as posts, articles, and dialogues authored by the subject. The server treats other character-based data as explanation data created by third parties concerning the specific subject, such as reviews, biographical descriptions, or commentary describing the subject's personality or style. The server applies different preprocessing rules and labels according to the category. For direct record data, the server emphasizes preservation of sentence-level structure and lexical choices, while for explanation data, the server extracts descriptive phrases that indicate style attributes or personality traits.

The server analyzes the explanation data to extract feature values indicating a vocabulary tendency, a writing style tendency, and a thinking tendency of the specific subject. The server uses natural language processing software to identify characteristic terms, collocation patterns, syntactic patterns, and sentiment distributions. The server computes statistical features such as word frequency distributions, n-gram frequencies, sentence length distributions, and part-of-speech tag sequences. The server also computes semantic features using embedding representations produced by a language model or an embedding model. The server aggregates these features into a style profile associated with the specific subject. The style profile is stored in a structured data format, for example, as a record containing vectors of numerical values and lists of representative expressions. Because the server explicitly encodes stylistic tendencies into numerical feature vectors, the generative AI model can be conditioned in a non-conventional manner that improves controllability and consistency of style imitation.

The server trains or adjusts a generative AI model by using the preprocessed character-based data and the style profile. In one embodiment, the generative AI model is a transformer-based neural network comprising an embedding layer, multiple self-attention layers, feed-forward layers, and a final output layer that predicts token probabilities. The server uses a machine learning framework to implement the neural network. The server initializes the model parameters from a pre-trained language model or from random values and then performs gradient-based optimization.

The server constructs training examples by combining token sequences from the subject's record data with associated style feature values from the style profile. The server appends or injects condition information into the input sequence, for example, by adding special tokens or control codes that encode style attributes, or by concatenating style feature vectors to token embeddings. The server defines a loss function such as a cross-entropy loss over predicted tokens, optionally augmented by a regularization term that encourages alignment between generated style and target style features. The server executes a training loop in which the server repeatedly performs a forward pass to compute model outputs, computes the loss, performs backpropagation to compute gradients, and updates model parameters by using an optimization algorithm such as Adam. The server tracks training metrics such as perplexity and style consistency scores, and adjusts hyperparameters such as learning rate and batch size accordingly. By incorporating explicit style feature vectors into the generative AI model's input and loss function, the server improves the precision with which the model reproduces expression style and thinking style of the specific subject while maintaining computational efficiency.

The server receives a prompt sentence including instruction content from the user as input. The terminal presents a text input area to the user. The user enters one or more prompt sentences, such as:

“Please rewrite the following paragraph in the style of the specific author, keeping a reflective and metaphorical tone.”

“Answer the question ‘What is happiness?’ as if you were the specific author, using their typical narrative style.”

“Please continue this diary entry in the voice of the specific author, being reflective and slightly humorous.”

The terminal transmits the prompt sentence to the server as character-based data along with identifiers for the selected subject and optional context text. The server receives the prompt sentence and retrieves the style profile and any relevant context records for the subject from storage.

The server generates model input information by integrating the prompt sentence with condition information indicating the expression style and the thinking style of the specific subject. The server constructs a structured input object containing at least: (i) the prompt sentence text, (ii) style feature vectors, (iii) control parameters such as a target level of metaphorical density or formality, and (iv) optional conversation history. The server converts the prompt sentence and control tokens into token sequences, aligns them with the style feature vectors, and passes them to the generative AI model. The server thereby provides a non-conventional input representation in which high-level style constraints and low-level textual content are integrated in a single inference call. Because the server performs this integration using explicit style feature encoding, the model can respond with high stylistic fidelity without requiring separate, ad hoc rule-based post-processing.

The server recognizes an emotional state of the user. In one embodiment, the server analyzes the user's voice using acoustic features such as pitch variance, speaking rate, and energy distribution, and also analyzes the user's character-based input using sentiment analysis. The server uses a classifier, for example, a neural network or a support vector machine, trained on acoustic and textual features to output a probability distribution over emotional states such as happiness, sadness, anger, and calmness. The server selects a dominant emotional state based on threshold criteria or maximum probability. The server stores the estimated emotional state and uses it as additional condition information.

The server generates a prompt sentence including condition information indicating prosodic characteristics and speech style of a voice of the specific subject according to the emotional state. For example, if the user is detected as sad, the server may augment the condition information with attributes specifying a softer volume, slower speaking rate, and more empathetic lexical choices. The server instructs the generative AI model to generate text responses that reflect both the subject's style and the adapted emotional tone. At the same time, the server configures an acoustic data synthesis technique, such as a neural text-to-speech model, with parameters corresponding to the target prosody and voice characteristics. The server thus coordinates text generation and acoustic synthesis with shared style and emotion-related condition information, which reduces mismatch between textual and vocal expression and improves user perception of coherence.

The server inputs character-based output data from the generative AI model to the acoustic data synthesis technique. The server uses an acoustic synthesis model such as a sequence-to-sequence neural network with attention and a vocoder network to convert the text into acoustic waveforms. The server also uses a speaker embedding or voice profile that represents the voice characteristics of the specific subject. By combining the text output with speaker embeddings and prosodic control parameters, the server generates acoustic data that closely imitates voice characteristics and speech style of the specific subject. The server encodes the output audio in a standard format, stores it if necessary, and transmits it to the terminal.

The terminal receives the generated character-based output and acoustic data from the server. The terminal displays the text on the screen and plays the audio through the audio output device. The user thereby experiences a dialogue that combines subject-specific textual style, subject-like vocal characteristics, and a tone adapted to the user's emotional state. The user may further input additional prompt sentences, and the processing described above is repeated, with conversation history and style features being reused. Because the server reuses preprocessed data structures and a trained generative AI model, subsequent interactions require only inference operations and minimal preprocessing, which increases throughput and reduces latency in a multi-user environment.

The server improves computer technology in several ways beyond a mere automation of human tasks. First, the server introduces specialized data structures that distinguish between direct subject records and third-party explanations and encode style features separately from raw text, which allows the generative AI model to be conditioned in a modular and reusable manner. This separation reduces redundancy and improves cache locality and memory usage during training and inference, thereby increasing processing speed and decreasing storage requirements. Second, the server uses an integrated pipeline for acquisition, preprocessing, feature extraction, model training, style conditioning, emotional adaptation, and audio synthesis, which reduces the number of intermediate data conversions and network round-trips compared to conventional disjoint systems. This integrated architecture reduces communication load and improves overall system throughput.

Third, the server uses a non-conventional method of combining prompt sentences with style feature vectors and emotional state features as model input information. This method alters the computation path within the transformer network by modulating attention weights and token predictions in accordance with explicit style and emotion signals. By doing so, the server achieves higher style consistency and lower error rates in persona imitation than systems that only rely on textual prompts without explicit feature conditioning. Fourth, the server employs specific loss functions and training strategies that encourage alignment between predicted style distributions and target style profiles, which leads to improved convergence behavior and reduced training time. The server can optionally perform data augmentation by synthetically varying sentence structure or paraphrasing while preserving style labels, thereby increasing the robustness of the generative AI model to input variation.

In alternative embodiments, the server may use different architectures for the generative AI model, such as encoder-decoder transformers, recurrent neural networks with attention, or mixtures of experts that route inputs to specialized style experts. The server may also use different acoustic models for speech recognition and synthesis, including convolutional neural network-based systems, autoregressive models, or non-autoregressive models. The server may execute the training and inference processes on different hardware configurations, such as distributed GPU clusters or specialized accelerators. The server may store style profiles in different types of databases, including relational databases, key-value stores, or graph databases.

The server may further implement different strategies for emotional state estimation, such as combining physiological sensor data with acoustic and textual features, or using multi-task learning models that jointly learn to predict emotion and style consistency. The terminal may be implemented on various hardware platforms, including smartphones, tablet computers, desktop computers, or dedicated communication devices. The terminal may also provide additional interface modalities, such as haptic feedback or augmented reality displays, without departing from the scope of the invention.

In each of these embodiments, the common feature is that the server executes a concrete sequence of data transformations and neural network computations, using explicit style and emotion features, to generate both text and audio outputs in a way that improves the efficiency, accuracy, and controllability of persona-specific dialogue reproduction in a computing environment.

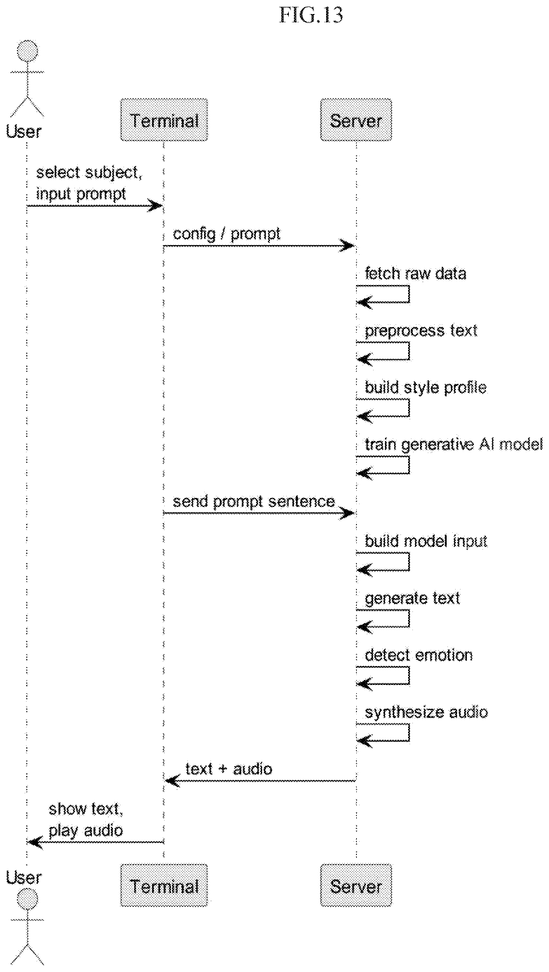

The following describes the processing flow using FIG. 13.

### Step 1

The user operates the terminal to specify a target subject and initial conditions.

The user inputs, via a graphical user interface on the terminal, a subject identifier (for example, a name or ID), one or more data source identifiers (for example, website URLs or service endpoints), and optional constraints such as time ranges or content types.

The terminal receives this input as character-based data, validates formats (for example, checks that URLs are syntactically valid), and encapsulates the information into a request payload.

Input: user-specified subject identifier and data acquisition conditions.

Processing: the terminal converts interactive UI input into structured configuration data.

Output: a configuration message transmitted from the terminal to the server via a communication network.

### Step 2

The server receives the configuration message and initiates data acquisition for the specific subject.

The server parses the configuration message and stores the subject identifier and acquisition parameters in a configuration data structure.

The server uses an information acquisition function to send network requests (for example, HTTP GET or API calls) to the indicated data sources, and downloads raw text content, metadata, and, if available, communication history associated with the specific subject.

Input: configuration message including subject identifier and acquisition parameters.

Processing: the server converts configuration parameters into one or more network requests and accumulates the resulting responses in raw storage.

Output: raw subject-related record data and communication history stored in a raw-data repository on the server.

### Step 3

The server preprocesses the acquired raw data to create normalized character-based data.

The server loads the raw data from the raw-data repository into memory using data processing software.

The server performs removal of unnecessary information by stripping markup, scripts, URLs, extraneous whitespace, and other non-linguistic elements.

The server normalizes character strings (for example, case folding, Unicode normalization, and conversion between character width variants) and segments the normalized text into unit elements such as sentences and tokens using natural language processing software.

Input: raw record data and communication history associated with the specific subject.

Processing: the server transforms heterogeneous raw content into a clean, tokenized representation by applying string operations and tokenization algorithms.

Output: preprocessed character-based data organized as an analyzable data structure containing unit elements and associated metadata.

### Step 4

The server distinguishes data categories and constructs a style profile for the specific subject.

The server classifies preprocessed character-based data into at least two categories: direct subject records (for example, writings or utterances authored by the subject) and third-party explanation data describing the subject.

The server analyzes the direct subject records to compute statistics such as word frequency distributions, n-gram patterns, sentence length distributions, and part-of-speech sequences.

The server analyzes the explanation data to extract descriptive phrases and labels related to vocabulary tendencies, writing style tendencies, and thinking tendencies.

The server aggregates these statistics and descriptors into numerical feature vectors and structured attributes, thereby forming a style profile linked to the subject identifier.

Input: categorized preprocessed character-based data for the specific subject.

Processing: the server applies statistical analysis and feature extraction methods to transform text units into style feature vectors and structured descriptors.

Output: a style profile data structure representing vocabulary tendencies, writing style tendencies, and thinking tendencies of the specific subject.

### Step 5

The server configures and trains or adjusts a generative AI model using the preprocessed data and the style profile.

The server selects or loads a base generative AI model architecture, for example, a transformer-based neural network, and initializes its parameters.

The server constructs training examples by pairing token sequences from the direct subject records with style feature vectors and labels from the style profile.

The server defines a loss function, such as cross-entropy over predicted tokens, optionally augmented by regularization terms that encourage alignment between generated style and the style profile.

The server iteratively performs forward passes to compute model outputs, backpropagation to compute gradients, and parameter updates using an optimization algorithm.

Input: preprocessed character-based data and the style profile associated with the specific subject.

Processing: the server maps text units and style feature vectors into training batches and performs numerical optimization on model parameters.

Output: a trained or adjusted generative AI model whose behavior is conditioned to imitate the expression style and thinking style of the specific subject.

### Step 6

The user constructs a prompt sentence and sends a generation request from the terminal.

The user enters a natural-language instruction into an input field on the terminal, for example:

“Please rewrite the following paragraph in the style of the specific author, keeping a reflective and metaphorical tone.”

“Answer the question ‘What is happiness?’ as if you were the specific author, using their typical narrative style.”

“Please continue this diary entry in the voice of the specific author, being reflective and slightly humorous.”

The terminal accepts this prompt sentence as character-based data, optionally associates it with a selected subject identifier and past conversation snippets, packages the data into a request payload, and transmits the payload to the server.

Input: user-entered prompt sentence and optional context data.

Processing: the terminal converts free-form user input into a structured generation request containing the prompt sentence and subject selection information.

Output: a generation request message sent from the terminal to the server.

### Step 7

The server constructs model input information by integrating the prompt sentence with condition information.

The server receives the generation request, extracts the prompt sentence, and identifies the target subject identifier from the payload.

The server retrieves the style profile associated with the subject identifier from storage and obtains style feature vectors and relevant control attributes.

The server optionally retrieves conversation history and merges it with the new prompt sentence to form a context string.

The server combines the prompt sentence, style feature vectors, and context data into a unified model input representation, for example, by appending style control tokens to the prompt, by concatenating feature vectors with token embeddings, or by embedding them as separate conditioning channels.

Input: generation request including the prompt sentence and subject identifier, and the stored style profile for the subject.

Processing: the server transforms discrete prompt text and style features into a joint numerical input suitable for the generative AI model.

Output: model input information that encodes both the user's instruction and the subject-specific style constraints.

### Step 8

The server generates a text response with the generative AI model based on the model input information.

The server feeds the model input information into the generative AI model and performs inference to obtain probability distributions over output tokens.

The server applies a decoding strategy (for example, greedy decoding, beam search, or sampling with specified temperature and top-k thresholds) to select or sample a sequence of output tokens that satisfy the style constraints and follow the prompt sentence.

The server converts the sequence of output tokens back into character-based output data, forming one or more sentences that imitate the specific subject's expression style and thinking style.

Input: model input information including tokenized prompt sentence, style conditioning, and optional context.

Processing: the server applies neural network computations and decoding algorithms to map conditioned input into a generated token sequence.

Output: character-based output data representing a text response styled after the specific subject.

### Step 9

The server determines a user emotional state and adjusts style-related condition information.

The server optionally receives additional input that reflects the user's emotional state, such as voice recordings or emotional tags from the terminal.

The server extracts acoustic and textual features (for example, pitch variance, speech rate, lexical sentiment scores) and applies a classifier to estimate an emotional state category.

The server updates or refines condition information by adding or modifying parameters that reflect the emotional state, such as desired prosody (for example, softer and slower speech when the user is sad) and tone (for example, more encouraging language).

The server may regenerate or post-process the text response to better match the adjusted emotional tone.

Input: user-related acoustic and textual signals correlated with emotional state, and any existing style condition information.

Processing: the server converts user signals into emotional state labels and modifies condition information parameters accordingly.

Output: updated condition information that combines subject-specific style features with emotion-dependent control parameters.

### Step 10

The server generates acoustic data from the character-based output data and the condition information.

The server inputs the generated text response and the updated condition information into an acoustic data synthesis technique, such as a neural text-to-speech model with speaker embeddings.

The server encodes the subject's voice characteristics and speech style using a stored voice profile and modifies prosodic parameters based on the emotional state.

The server performs synthesis computations to produce an audio waveform that corresponds to the text response and exhibits the target subject's vocal style and the desired emotional prosody.

Input: character-based output data, subject voice profile, and condition information including prosodic and style parameters.

Processing: the server maps text and conditioning features into an acoustic waveform via a sequence of neural network transformations and signal processing steps.

Output: synthesized acoustic data representing speech that imitates the specific subject's voice and speaking style.

### Step 11

The server sends the generated outputs to the terminal, and the terminal presents them to the user.

The server packages the character-based output data and the synthesized acoustic data into a response message and transmits it to the terminal over the communication network.

The terminal receives the response, parses the message, displays the text response on the screen, and plays the audio through the speaker or headphones.

The user reads and/or listens to the generated response and may decide to input another prompt sentence, which restarts the interaction cycle.

Input: generated text and synthesized audio from the server.

Processing: the terminal converts the received data into displayable and playable formats, controls rendering on the display and audio hardware, and updates any conversational context shown to the user.

Output: a multimodal presentation of the subject-styled dialogue to the user, along with an updated local conversation state on the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems and content delivery systems that utilize machine learning typically process user inputs and generate responses in a uniform manner, without deeply integrating user-specific emotional context or detailed stylistic emulation of a particular person. In such systems, audio recognition, natural language generation, and emotion estimation are often implemented as loosely coupled modules, which leads to several technical drawbacks.

First, existing architectures usually treat speech recognition, emotion detection, and text generation as independent pipelines with minimal shared context. As a result, error propagation occurs across modules, and there is no structured mechanism for jointly optimizing recognition, style control, and emotional adaptation. This often produces responses that are semantically correct but lack coherence with the user's conversational history, and cannot faithfully maintain a consistent “persona” over multiple turns.

Second, conventional systems frequently apply generative AI models using generic input prompts that do not encode detailed style information, conversation history, and user emotional state in a unified and machine-interpretable way. In the absence of a rigorously structured prompt construction mechanism, the computational resources of the generative AI model are not effectively utilized, often resulting in unstable persona emulation, inconsistent tone, and low controllability over the output style. This limits the ability of the underlying computing system to deterministically reproduce the linguistic behavior of a specific person.

Third, many emotion-aware systems only annotate outputs at a superficial layer, for example by post-processing generated text or audio, instead of feeding emotion data back into the core generation process. This architectural separation prevents the system from exploiting emotion information as part of the conditioning context for the generative AI model. Consequently, the system cannot reliably generate responses that are both style-consistent and adaptively tuned to the user's moment-to-moment emotional state, which degrades user experience and wastes processing cycles on ineffective generations.

Fourth, typical implementations lack a unified mechanism for storing and exploiting structured dialogue history, prompt sentences, and emotion trajectories as reusable context for subsequent generations. Without such history management at the processor level, the system is unable to maintain long-term coherence, to reduce redundant processing, or to refine prompts based on previous interactions. This leads to inefficient use of memory and compute resources, as the generative AI model must repeatedly infer context from scratch.

Accordingly, there is a need for an improved computer-implemented system that: (i) tightly integrates audio processing, emotion analysis, and generative AI-based style emulation through explicitly structured prompt sentences; (ii) uses accumulated dialogue history, style information, and emotion states as first-class context in the generation pipeline; and (iii) programmatically controls speech synthesis parameters based on emotion-linked prompts. Such a system should improve the technical functioning of the overall computing architecture by increasing controllability, coherence, and efficiency in generating style-consistent and emotion-adaptive responses that emulate a specific person.

The specific processing by the specific processing unit 290 of the data processing device 12 in Application Example 2 is realized by the following means.

The present invention provides a server comprising a processor configured to acquire input audio information from a user terminal, analyze an audio signal included in the input audio information by using an audio processing technology to extract acoustic features, and convert the audio signal into character string information; to acquire the character string information and person information, generate style information for imitating a linguistic expression and a thought pattern of a specific person on the basis of the person information, and construct a prompt sentence including the style information, the character string information, dialogue history information, and external information for input to a generative AI model; to acquire the input audio information and facial image information, estimate an emotional state of the user by using an emotion analysis technology that integrates voice-based emotion analysis and facial-based emotion analysis, and generate an emotion-linked prompt sentence for adjusting prosody and a manner of speech of the specific person by adding or changing conditions relating to response tone and speaking style in the prompt sentence in accordance with the emotional state; to acquire a mimic response character string output from the generative AI model in response to the prompt sentence, convert the mimic response character string into synthetic audio on the basis of audio features associated with the specific person by using a speech synthesis technology, and adjust a speed, a volume, and prosody of the synthetic audio in accordance with the emotional state to generate an output; to transmit the mimic response character string and the synthetic audio to the user terminal and cause the user terminal to display the mimic response character string and reproduce the synthetic audio; and to store, in a storage device, the dialogue history information, the emotional state, and the prompt sentence as accumulated information and refer to the accumulated information as context information when generating a subsequent prompt sentence. This enables the computing system to tightly couple audio recognition, emotion estimation, generative AI-based style emulation, and speech synthesis in a unified control flow, thereby improving the technical performance of the system in terms of controllable persona consistency, emotion-adaptive response generation, and efficient context reuse across multi-turn interactions.

The term “audio processing technology” refers to a computational technique or combination of algorithms executed by a processor to analyze digital audio signals, including operations such as feature extraction, noise reduction, segmentation, and conversion of the audio signals into symbolic or textual representations.

The term “input audio information” refers to digital data representing sound captured from a user or an environment, which is provided to the system as an input signal for analysis by the audio processing technology.

The term “acoustic features” refers to numerical or symbolic parameters derived from an audio signal, including but not limited to pitch, energy, spectral components, formants, and temporal patterns, which are used by the processor to characterize speech or other sounds.

The term “character string information” refers to text data representing linguistic content, including sequences of characters, words, or tokens obtained by converting audio information or other symbolic inputs into a textual form.

The term “person information” refers to data associated with a specific person, including text information, metadata, or statistical descriptors that are used by the processor to model the linguistic expression and thought pattern of that person.

The term “style information” refers to structured data or parameters that represent a linguistic style and thought pattern of a specific person, including typical vocabulary, sentence structures, tone, and rhetorical habits, which are generated by the processor on the basis of the person information.

The term “prompt sentence” refers to a text instruction or set of text instructions constructed by the processor and provided as an input to a generative AI model, the text instruction specifying conditions, context, or constraints for generating a desired output.

The term “generative AI model” refers to a machine-implemented model, such as a neural network, that receives a prompt sentence or other input data and generates text or other content by statistically modeling patterns learned from training data.

The term “dialogue history information” refers to stored data representing past interactions between a user and the system, including previous user utterances, system responses, timestamps, and associated metadata, which are used as context for subsequent processing.

The term “external information” refers to data obtained from sources outside the immediate dialogue, including documents, databases, or network resources, that can be incorporated into the prompt sentence to provide additional context or factual content.

The term “facial image information” refers to digital image data or video frames representing at least a user's face, which are processed by the system to detect facial expressions or other visual cues for emotion estimation.

The term “emotion analysis technology” refers to a computational technique or combination of algorithms executed by a processor to estimate an emotional state of a user on the basis of input data such as audio signals, facial image information, or other biometric information.

The term “emotional state” refers to a machine-interpretable representation of a user's emotion, such as sadness, joy, anger, fear, or a numerical score vector corresponding to one or more emotion categories.

The term “emotion-linked prompt sentence” refers to a prompt sentence that has been modified or augmented by the processor with conditions, constraints, or instructions that explicitly reflect a user's emotional state, thereby influencing the manner of response generation.

The term “response tone” refers to qualitative properties of a generated response, such as politeness level, warmth, formality, or intensity, which are controlled by the system according to the emotional state and desired style.

The term “speaking style” refers to patterns of verbal expression, including word choice, sentence length, rhythm, and discourse structure, associated with a specific person or persona and used by the system to emulate that person.

The term “mimic response character string” refers to a text output generated by the generative AI model that is intended to imitate the linguistic expression and thought pattern of a specific person as specified by the prompt sentence.

The term “speech synthesis technology” refers to a computational technique or combination of algorithms executed by a processor to convert text, including the mimic response character string, into synthetic audio signals that resemble natural speech.

The term “synthetic audio” refers to audio data generated by the speech synthesis technology from text input, which simulates human speech and may be configured to approximate the voice characteristics of a specific person.

The term “audio features associated with the specific person” refers to parameters representing voice characteristics of a specific person, such as pitch range, timbre, speaking rate, and prosodic patterns, which are used to control the speech synthesis technology.

The term “prosody” refers to suprasegmental aspects of speech, including intonation, stress, rhythm, and timing, which the system adjusts to reflect a target style or emotional state.

The term “terminal device” refers to an information processing apparatus, such as a smartphone, tablet, wearable device, kiosk, or other user-operated device, that exchanges data with the server, presents outputs to the user, and may capture user inputs.

The term “communication control” refers to operations performed by the processor for managing transmission and reception of data between the server and the terminal device, including protocol handling, session management, and error control.

The term “storage device” refers to a hardware component or logical memory resource, such as a magnetic storage medium, solid-state memory, or database system, in which the processor stores dialogue history information, emotional states, prompt sentences, and related data.

The term “accumulated information” refers to data that has been stored over time in the storage device, including dialogue history information, emotional states, prompt sentences, and derived contextual data, which are reused by the processor in subsequent processing.

The term “context information” refers to information derived from accumulated information, including prior utterances, prior responses, previously detected emotions, and past prompt structures, that is used by the processor to condition or refine a new prompt sentence.

The term “recorded documents” refers to text data representing previously created written materials associated with a specific person, such as letters, notes, or articles, that are used as part of the person information.

The term “utterance records” refers to data representing past spoken content produced by a specific person, including transcripts or annotations of speech, which are used for style analysis and modeling.

The term “journal information” refers to text data representing diary-like or log-like entries associated with a specific person, which are used to capture characteristic expressions and thoughts of the person.

The term “electronic communication histories” refers to text data representing communications conducted by a specific person through electronic media, such as messages, posts, or chats, which are used to build the person information.

The term “third-party descriptive documents” refers to text data created by individuals other than the specific person, describing the specific person's characteristics, behavior, or style, which are used to supplement the person information.

The term “preprocessing” refers to a sequence of computational operations applied to text information by the processor, including normalization, tokenization, segmentation, cleaning, and filtering, to prepare the text information for feature extraction or input to a generative AI model.

The term “feature extraction processing” refers to computational operations applied by the processor to derive numerical or symbolic representations from text information, such as frequency statistics, embeddings, or style descriptors, which constitute part of the style information.

The term “voice emotion analysis result” refers to a machine-interpretable output produced by an emotion analysis technology from input audio information, indicating a predicted emotional state or scores over multiple emotion categories.

The term “facial emotion analysis result” refers to a machine-interpretable output produced by an emotion analysis technology from facial image information, indicating a predicted emotional state or scores over multiple emotion categories inferred from facial expressions.

The term “consoling response” refers to a type of generated response whose tone, content, and style are configured by the processor to comfort or soothe the user in reaction to a negative emotional state.

The term “encouraging response” refers to a type of generated response whose tone, content, and style are configured by the processor to support, motivate, or reassure the user.

The term “plain explanatory response” refers to a type of generated response whose tone and content are configured by the processor to provide an easy-to-understand explanation with reduced technical complexity or formality.

The term “concise response” refers to a type of generated response whose length and structure are configured by the processor to be brief and focused, omitting unnecessary detail.

In one embodiment, a server cooperates with one or more terminal devices to implement a system that generates styled and emotion-adaptive responses in the manner of a specific person. The server comprises at least one processor, a memory storing executable instructions and data structures, a storage device, and a communication interface. The terminal comprises at least one processor, a memory, a microphone, a camera, a display, a speaker, and a communication interface.

The server executes a program that is divided into functional modules, including an audio acquisition and analysis module, an automatic speech recognition module, a feature extraction module, an emotion analysis module, a style information generation module, a prompt sentence construction module, a generative AI model interface module, a speech synthesis module, a history management module, and a communication control module. The terminal executes a client program including an input acquisition module, a user interface module, and a local media playback module.

The server uses commodity computing hardware such as multi-core central processing units (CPUs), optional graphics processing units (GPUs), and high-speed random access memory (RAM). The server stores data in a non-transitory storage device such as a magnetic disk array or a solid-state drive. The terminal is implemented as an information processing device, such as a smartphone, a tablet, a head-mounted display, or a kiosk terminal, using integrated microphones, cameras, and speakers. The server and the terminal communicate over a packet-switched network using a transport protocol such as Transmission Control Protocol and an application protocol such as Hypertext Transfer Protocol Secure.

The server applies an audio processing technology to input audio information captured by the terminal. The audio processing technology includes pre-emphasis filtering, framing, windowing, and spectral analysis implemented by the processor. The server converts the captured waveform into a sequence of acoustic feature vectors, for example Mel-frequency cepstral coefficients (MFCCs), log-Mel spectrograms, pitch contours, and energy features. The server passes these features to an automatic speech recognition engine that can be implemented as a hybrid deep neural network-hidden Markov model or as an end-to-end neural architecture such as a convolutional-recurrent network or a transformer encoder with a connectionist temporal classification objective. In one concrete implementation, the server can interface with a cloud-based speech-to-text service such as a generic cloud speech recognition API, but the underlying processing internally uses the described feature extraction and neural architectures.

The server converts the recognized speech into character string information, represented as a token sequence stored in a structured data format, for example an array of integer token identifiers referencing a vocabulary mapping. The server may normalize the character string information by applying subword tokenization, punctuation restoration, and language-specific normalization rules.

The server generates person information from stored text information related to a specific person. The server stores person information in the storage device as a collection of documents, where each document is represented by a structured record, including fields for document type (recorded document, utterance record, journal, electronic communication, third-party description), timestamp, language, and text content. The server preprocesses each document by performing operations such as Unicode normalization, sentence segmentation, stop-word filtering, and syntactic parsing. The server then applies a feature extraction processing step to compute vector embeddings of sentences and documents, for example by using a transformer-based encoder network that maps token sequences into high-dimensional vectors. These embeddings serve as style descriptors that characterize the linguistic expression and thought pattern of the specific person.

The server generates style information by aggregating the computed embeddings and computing statistical descriptors such as mean vectors, covariance matrices, and frequency distributions of part-of-speech tags, syntactic constructions, and discourse markers. The server stores style information in a style profile data structure associated with the specific person. The style profile may include a list of characteristic phrases, preferred sentence lengths, typical sentiment distribution, politeness level, and domain-specific terminology. Because the style information is computed automatically from many documents, the system extracts patterns that would not be consistently identified by manual rule definition, thereby improving consistency and coverage.

The server constructs a prompt sentence for a generative AI model by combining multiple components: (i) a role description indicating that the model should emulate a specific person, (ii) sample text snippets drawn from the style profile, (iii) the latest character string information obtained from the user's utterance, (iv) dialogue history information retrieved from the history management module, and (v) external information such as news articles or product specifications. The server formats these components into a structured natural language instruction. An example prompt sentence is:

“You are emulating the speaking style of the user's grandfather. Based on the following diary excerpts, talk to the user as if you are the grandfather. The user sounds tired and sad. Speak gently and supportively. Diary excerpts: ‘When I came home tired from work, I always told myself to be proud of what I had done.’ ‘Family is the most important thing, even on the hardest days.’ The user said: ‘I feel very tired today.’ Respond in one or two sentences as the grandfather.”

The server generates prompt sentences algorithmically according to a non-trivial rule set. The rule set specifies, for example, that dialogue history information within a configurable window of turns is summarized and included after a “Previous conversation” label, that emotion-linked conditions are placed immediately before the user's latest utterance, and that sample style phrases are limited to a target token budget to control computational load. This structured prompt construction improves the efficiency and stability of the generative AI model by providing explicit conditioning context, reducing ambiguity that would otherwise require the model to infer context implicitly from long unstructured text.

The server interfaces with a generative AI model that is implemented as a deep neural network, such as a transformer-based language model with multiple self-attention layers, feed-forward sublayers, and residual connections. The generative AI model is trained in advance on large corpora using a training objective such as next-token prediction with a cross-entropy loss. During training, the model parameters, including weight matrices and biases, are updated by an optimization algorithm such as stochastic gradient descent with adaptive learning rate adjustment. The server may further fine-tune the generative AI model on a subset of person-related documents and dialogue data to align its output style with the specific person's style, using techniques such as supervised fine-tuning and, optionally, reinforcement learning from preference data to enforce safety and appropriateness constraints.

The server does not simply let the generative AI model generate unconstrained responses. Instead, the server enforces non-conventional control rules at the prompt level and at the output filtering level. For example, the server limits the maximum token count of each reply based on device capabilities and latency requirements, replaces sensitive content based on lexical and semantic filters, and adjusts the decoding strategy (e.g., top-k sampling, nucleus sampling, or constrained beam search) according to the user's emotion state, thereby balancing diversity against predictability. These controls are implemented by the generative AI model interface module according to configuration parameters stored in the memory.

The server estimates an emotional state of the user by applying an emotion analysis technology to both audio and facial image information. The audio-based emotion subsystem uses acoustic features, such as pitch contours, energy trajectories, spectral flux, and voice quality measures, as input to a neural classifier, for example a recurrent or transformer-based network with a softmax output over discrete emotion categories. The facial-based emotion subsystem uses facial image information captured by the terminal camera. The server or the terminal runs a convolutional neural network trained on facial expression datasets to output probabilities for emotions such as happiness, sadness, anger, and neutrality. The server fuses these two emotion analysis results using a weighted averaging or Bayesian fusion algorithm, producing a combined emotion vector and selecting the emotion category with maximum posterior probability as the final emotional state. Because the server fuses multi-modal features at a numeric representation level, the system achieves higher robustness to noise and occlusion than systems that rely on only one modality.

The server creates an emotion-linked prompt sentence by modifying the base prompt sentence according to the emotion vector. If the user's emotional state is classified as sadness with a probability above a threshold, the server inserts conditions such as “Use a gentle and comforting tone” and “Avoid using harsh or critical expressions” into the prompt sentence. If the user's emotional state is classified as joy, the server inserts conditions such as “Use a brighter and more enthusiastic tone.” By adding these conditions as explicit natural language instructions, the server directs the generative AI model to adjust not only lexical choices but also narrative structure, sentence length, and discourse markers. This approach differs from conventional systems that only post-process the generated text or audio; in the present system, emotion information is fed into the core generative process, improving alignment between content, style, and the user's current state.

The server obtains a mimic response character string as the output of the generative AI model. The server then applies a speech synthesis technology to convert the mimic response character string into synthetic audio. The speech synthesis technology is implemented as a neural text-to-speech model, for example a sequence-to-sequence acoustic model with attention, followed by a neural vocoder such as a waveform generator, which produces time-domain waveforms. The server conditions the acoustic model on audio features associated with the specific person, such as target pitch range, average speaking rate, and timbre embeddings learned from the person's recorded voice. In one implementation, the server uses a multi-speaker text-to-speech model, where each speaker is represented by a speaker embedding vector; the server maps the specific person to a learned or adapted speaker embedding and passes this embedding along with the text tokens. The model then generates synthetic audio whose voice characteristics approximate those of the specific person.

The server further adjusts prosody of the synthetic audio based on the user's emotional state. The server modifies prosodic parameters such as pitch scaling, duration stretching, and amplitude scaling before or after waveform generation. For example, when the emotional state indicates sadness, the server decreases the average pitch, reduces amplitude, and slightly increases duration to produce slower, softer speech. When the emotional state indicates excitement, the server increases pitch variability and speaking rate. Because these adjustments are based on numeric emotion vectors and prosodic control parameters, the server can apply consistent transformations across different utterances, reducing variance and improving predictability.

The terminal acquires input audio information and facial image information and sends them to the server. The terminal implements an audio capture buffer in memory to store raw pulse-code modulation data, compresses it using a codec such as Opus or Advanced Audio Coding to reduce network bandwidth, and transmits it to the server via a streaming protocol. The terminal captures image frames from the camera at a configurable frame rate, encodes them in a compressed image or video format, and transmits them to the server when emotion analysis is enabled. The terminal also receives mimic response character strings and synthetic audio, decodes the audio stream, and reproduces the synthetic audio via a speaker while simultaneously displaying the character strings on the display.

The user interacts with the system by operating the terminal's user interface. The user can select a particular person profile, such as a deceased relative, a public figure, or a fictional character, through a graphical menu. The user can also configure preferences, such as a preference for shorter or more detailed responses, a preference for more humorous or more formal style, and whether to use audio, text, or both. The server receives these preferences and stores them as session parameters, which are then included in the prompt sentence as additional conditions. An example prompt sentence incorporating user preferences is:

“You are emulating the speaking style of a friendly mentor. The user prefers short and slightly humorous answers. Use the following style descriptions and sample phrases, and respond briefly and with light humor. Sample phrases: ‘Let's tackle this one step at a time.’ ‘No need to worry, you've got this.’ The user asked: ‘Can you explain this concept to me?’ Respond as the friendly mentor in one or two short sentences.”

In another example, the user requests explanation of news in the style of a scientist. The server constructs the following prompt sentence:

“You are a scientist explaining the latest science news. Emulate the speaking style described in the following style profile and sample excerpts. Keep the explanation understandable to a general audience. Sample excerpts: ‘We can think of this phenomenon as a kind of invisible field affecting everything around us.’ ‘What matters here is not just the numbers, but the underlying mechanism.’ News text: ‘[news article text]’. Rewrite this news text as if you, the scientist, are explaining it to the user.”

By encoding style, emotion, history, and external content in a structured prompt sentence, the system causes the generative AI model to execute computations that are more targeted and efficient than generic, context-free generation. The system reduces the number of tokens that the model must infer purely from latent context, which, in turn, reduces computational cost and improves output stability.

The server manages dialogue history, emotional states, and prompt sentences using specialized data structures. The server stores each user utterance and system response in a dialogue history table with fields for speaker identifier, timestamp, tokenized content, detected emotion, and any content tags. The server also stores the constructed prompt sentences and the resulting generative AI outputs in a prompt log. When constructing a new prompt sentence, the server retrieves a subset of past entries using a windowing function and, optionally, a relevance scoring function based on semantic similarity. These entries are compressed into a short textual summary that is inserted into the prompt as “Previous conversation.” This history management reduces memory usage and network traffic by avoiding retransmission of all past content, while still preserving coherence. It also improves processing speed because the generative AI model receives only the most relevant context instead of an unbounded dialogue history.

The server improves computer technology beyond mere automation of human tasks in several ways. First, the integrated, multi-modal emotion analysis and fusion algorithm enables more accurate and robust emotion estimation under noisy conditions than human perception alone, leading to quantifiable reductions in misclassification rates. Second, the structured prompt sentence construction, which jointly encodes style information, history, emotion, and external data, reduces the entropy of the generative AI model's input distribution, allowing the model to converge on consistent persona behavior with fewer parameters and lower inference latency. Third, the server's prosodic control over synthetic audio, tied to numeric emotion vectors and style profiles, yields deterministic and repeatable modifications of speech characteristics that cannot be easily achieved by manual editing or simplistic post-processing.

The server, by implementing these specific data structures (style profiles, dialogue history tables, prompt logs) and algorithmic modules (multi-modal emotion fusion, structured prompt construction rules, prosody adjustment control loops), realizes a computing architecture that improves the technical functioning of a generative AI-based dialogue system. The improvement manifests as increased response coherence across turns, reduced average latency due to constrained context windows, and reduced error rates in emotion-appropriate style switching, as measured by objective metrics.

In a variant embodiment, the terminal performs part of the emotion analysis locally. The terminal executes a lightweight facial expression recognition model optimized for mobile hardware and transmits only emotion category labels and confidence scores to the server instead of raw images. This reduces communication bandwidth and improves privacy. The server integrates these local emotion labels with server-side audio emotion analysis to compute the final emotional state. In another variant, the server offloads part of the speech synthesis workload to edge computing nodes to reduce end-to-end latency in geographically distributed deployments.

In yet another embodiment, the server supports multiple generative AI models. The server selects a particular generative AI model or model configuration based on the complexity of the requested task, the length of the dialogue context, and available computational resources. For simple tasks or short replies, the server may use a smaller model to reduce latency. For complex tasks such as multi-paragraph narrative generation, the server uses a larger model with extended context length. The server adjusts the prompt sentence formatting to match the selected model's tokenization and maximum context constraints. This dynamic model selection and prompt adaptation further improves processing efficiency and reduces computational cost.

In a further embodiment, the server applies data augmentation and continual learning to refine the style information over time. The server collects anonymized dialogue segments where the persona emulation is rated as successful according to an internal consistency metric or external feedback. The server uses these segments as additional training samples in periodic fine-tuning sessions, applying an error function that penalizes deviations from desired style and emotion alignment. During fine-tuning, the server updates a subset of model parameters while freezing base layers, using gradient descent with a low learning rate to avoid catastrophic forgetting. This process gradually improves the model's ability to maintain a consistent persona over long dialogues, providing a technical improvement in generative stability.

Because the server explicitly structures and controls the data flow from audio and image acquisition, to feature extraction, emotion estimation, prompt sentence construction, generative AI inference, and prosody-controlled speech synthesis the system provides an integrated and non-conventional technical solution that enhances the underlying computing processes. The system is not limited to automating human conversation; it implements specific computational mechanisms that enhance processing speed, accuracy, and resource usage, which are central concerns of computer technology.

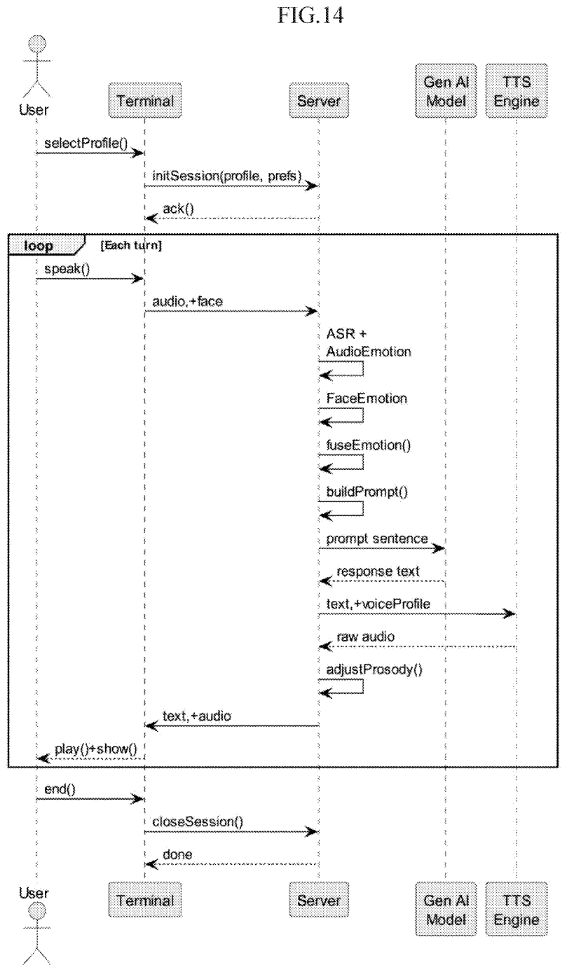

The following describes the processing flow using FIG. 14.

### Step 1

User selects a specific person profile and preferences on the terminal.

The terminal displays a list of person profiles (for example, “grandfather”, “scientist”, “mentor”) and configuration options (for example, “short replies”, “humorous tone”, “audio+text”). The user selects one profile and sets preferences.

Input: user touch or click operations on the terminal UI.

Output: a profile selection record including a person ID, preference flags, and a new session ID stored in the terminal memory.

### Step 2

Terminal sends session initialization data to the server.

The terminal packages the person ID, preference flags, terminal capabilities (for example, audio supported, camera enabled), and session ID into a structured message and transmits it to the server via a secure network connection.

Input: profile selection record and session ID.

Output: a session initialization request message delivered to the server communication interface.

### Step 3

Server initializes a session and loads person information.

The server parses the session initialization request, allocates a session context in memory, and retrieves person information (documents, utterance records, journals, electronic communications, third-party descriptions) from a storage device.

Input: session initialization request message.

Output: an in-memory session context object containing person information references and user preference flags.

### Step 4

Server preprocesses person-related text and generates style information.

The server reads raw text documents for the specific person, applies Unicode normalization, sentence segmentation, tokenization, and stop-word removal, and then computes sentence and document embeddings using a text encoder (for example, a transformer encoder). The server aggregates these embeddings to derive style descriptors (mean vectors, typical phrase list, sentence length distribution, and domain term list).

Input: person information documents associated with the person ID.

Output: a style profile structure containing style information stored in association with the session context.

### Step 5

User starts speaking to the terminal.

The user produces spoken input such as a question or remark (for example, “I feel very tired today” or “Explain today's science news”). The terminal microphone converts sound pressure into a digital waveform and buffers the audio.

Input: acoustic signal from the user.

Output: a stream of digital audio samples stored in an input buffer on the terminal.

### Step 6

Terminal captures audio and facial image data and sends them to the server.

The terminal segments the audio stream into frames, applies optional compression, and sends the audio packets to the server. In parallel, the terminal captures facial image frames from the camera at a predetermined frame rate and transmits the encoded images or a reduced resolution version to the server.

Input: audio sample buffer and camera image frames.

Output: an audio packet stream and an image packet stream transmitted to the server.

### Step 7

Server performs audio feature extraction and speech recognition.

The server receives the audio packets, reconstructs the waveform, and applies pre-emphasis, framing, and windowing. The server computes acoustic features (for example, MFCCs and pitch) and feeds these into an automatic speech recognition model. The model outputs probabilistic sequences of phonemes and words, which the server decodes into text using a beam search decoder.

Input: reconstructed digital audio waveform from the terminal.

Output: character string information representing the recognized user utterance, with associated confidence scores.

### Step 8

Server performs audio-based emotion analysis.

The server reuses or recomputes acoustic features (for example, pitch contour, energy, spectral slope) and feeds them into an emotion classifier network. The classifier computes emotion probability scores over categories such as sadness, joy, anger, and neutral. The server selects the highest-probability emotion and stores it as an audio-based emotion result.

Input: acoustic feature vectors derived from the user audio.

Output: an audio emotion vector and an audio emotion label stored in the session context.

### Step 9

Server performs facial-based emotion analysis.

The server receives facial image frames, normalizes them (cropping to face region, resizing, and color normalization), and inputs each frame into a convolutional neural network trained on facial expressions. The network outputs emotion probability distributions. The server aggregates results across frames (for example, by averaging probabilities) to produce a single facial emotion vector and label for the utterance.

Input: facial image frames from the terminal.

Output: a facial emotion vector and a facial emotion label stored in the session context.

### Step 10

Server fuses audio and facial emotion results.

The server combines the audio emotion vector and facial emotion vector using a weighting rule or Bayesian fusion, computing a fused emotion vector. The server then selects the final emotional state as the category with the highest fused probability and stores the emotional state along with an intensity score.

Input: audio emotion vector and facial emotion vector.

Output: a fused emotional state record (emotion label and intensity) associated with the current user utterance.

### Step 11

Server updates dialogue history.

The server creates a dialogue history entry including the recognized user utterance text, timestamp, fused emotional state, and session ID. The server inserts the entry into a dialogue history table in the storage device and optionally maintains a sliding window of recent entries in memory.

Input: recognized user utterance text and fused emotional state.

Output: an updated dialogue history table entry and an in-memory recent-context list.

### Step 12

Server selects relevant history and style samples.

The server retrieves recent dialogue history entries for the session (for example, the last N turns) and summarizes or concatenates them into a compact representation. The server also selects representative style samples from the style profile, such as a few typical phrases or sentences. Relevance may be determined by semantic similarity between the current utterance and stored documents.

Input: dialogue history entries for the session and style profile structure.

Output: a set of selected history snippets and style sample texts.

### Step 13

Server constructs a base prompt sentence.

The server assembles a natural language instruction specifying (i) the role of the generative AI model (emulating the specific person), (ii) style sample texts, (iii) selected dialogue history, (iv) user's current utterance, and (v) external information if needed. The server formats these components into a continuous prompt sentence.

Input: style sample texts, history snippets, recognized user utterance, and external data.

Output: a base prompt sentence string stored in the session context.

### Step 14

Server modifies the prompt sentence according to emotion and user preferences.

The server reads the fused emotional state and user preference flags (for example, “short”, “humorous”, “gentle”) from the session context. The server inserts additional conditions into the prompt sentence, such as “Use a gentle and comforting tone” or “Respond briefly and with light humor,” and reorders sections if required by a prompt template.

Input: base prompt sentence, fused emotional state, and user preference flags.

Output: an emotion-linked and preference-linked prompt sentence string ready for model input.

### Step 15

Server sends the prompt sentence to the generative AI model and receives a mimic response character string.

The server tokenizes the prompt sentence into model tokens, forwards them to a generative AI model (for example, a transformer-based language model) as input, and runs inference to predict output tokens one by one or in parallel. The server decodes the output tokens back into text, obtaining a mimic response character string that imitates the specific person's style.

Input: emotion-linked prompt sentence string.

Output: a mimic response character string and associated token-level probabilities.

### Step 16

Server post-processes the mimic response character string.

The server optionally truncates overly long responses, enforces content filters, and normalizes formatting (for example, adding punctuation or adjusting honorifics). The server may also annotate the text with tags for emphasis or pauses to be used in speech synthesis.

Input: raw mimic response character string from the generative AI model.

Output: a refined response text string suitable for speech synthesis and display.

### Step 17

Server converts the response text into synthetic audio with style conditioning.

The server submits the refined response text and a speaker embedding or voice profile derived from the specific person's audio features to a text-to-speech engine. The engine generates an acoustic representation (for example, a Mel-spectrogram) and then a time-domain waveform. The server receives the synthetic audio data and stores it temporarily.

Input: refined response text string and voice profile parameters.

Output: a synthetic audio waveform representing the response in the specific person's voice style.

### Step 18

Server adjusts prosody of the synthetic audio based on the emotional state.

The server applies signal processing or parameter transformations to adjust pitch, speed, and volume according to the fused emotional state. For example, the server may apply a time-stretching algorithm and a pitch-shifting algorithm, controlled by numeric factors computed from emotion intensity.

Input: synthetic audio waveform and fused emotional state record.

Output: an emotion-adjusted synthetic audio waveform ready for transmission.

### Step 19

Server packages and transmits the response to the terminal.

The server bundles the refined response text, the emotion-adjusted synthetic audio (or a URL to it), and metadata (for example, emotion label, timestamp) into a response message. The server encodes the audio into a compressed format and sends the response message over the network to the terminal.

Input: refined response text, emotion-adjusted synthetic audio, and metadata.

Output: a response message delivered to the terminal communication interface.

### Step 20

Terminal receives, decodes, and presents the response.

The terminal parses the response message, displays the refined response text on the screen, and decodes the compressed audio into a playable waveform. The terminal then plays the audio through its speaker and optionally synchronizes text display as subtitles.

Input: response message from the server.

Output: a visual and auditory presentation of the mimic response to the user.

### Step 21

User continues the interaction or ends the session.

The user listens to the response, reads the displayed text, and may ask a follow-up question or issue a new request using voice or text input. If the user continues, Steps 5 through 20 are repeated as part of a multi-turn dialogue. If the user ends the session, the terminal sends a termination signal, and the server closes the session context and releases resources.

Input: user's decision to continue or stop interaction.

Output: either a new cycle of user input leading to another processing sequence or a session termination record on the server.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

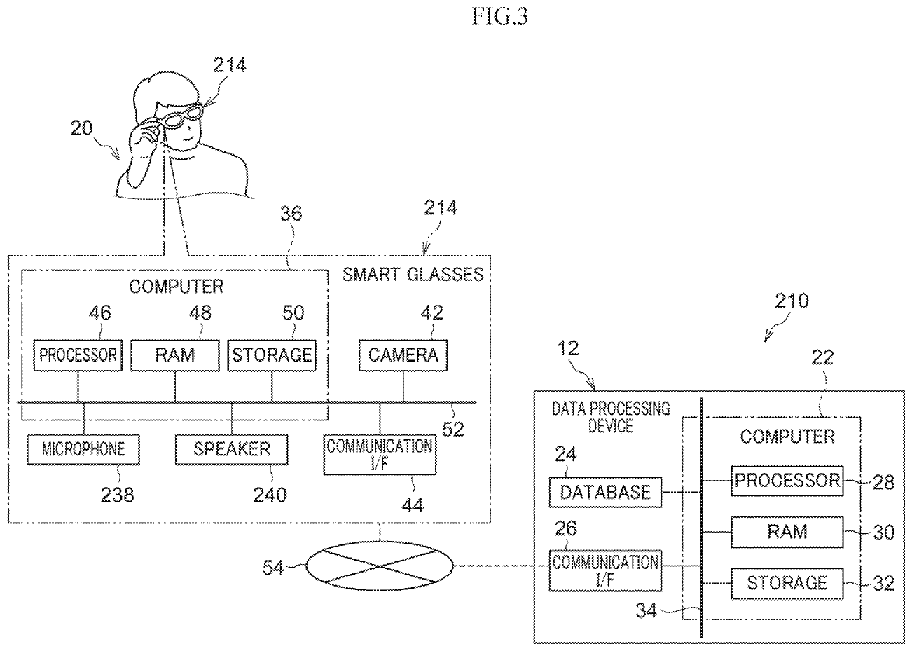

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

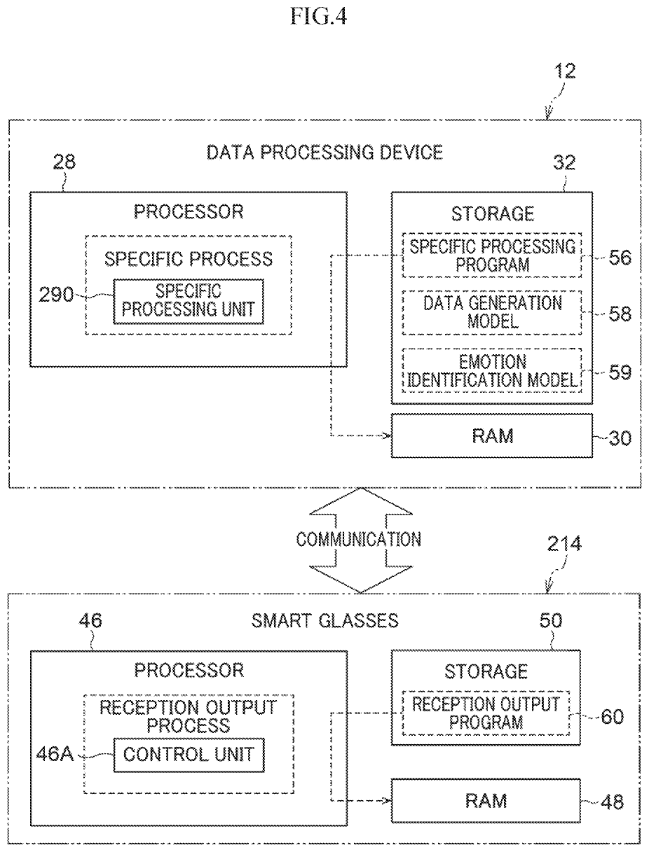

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

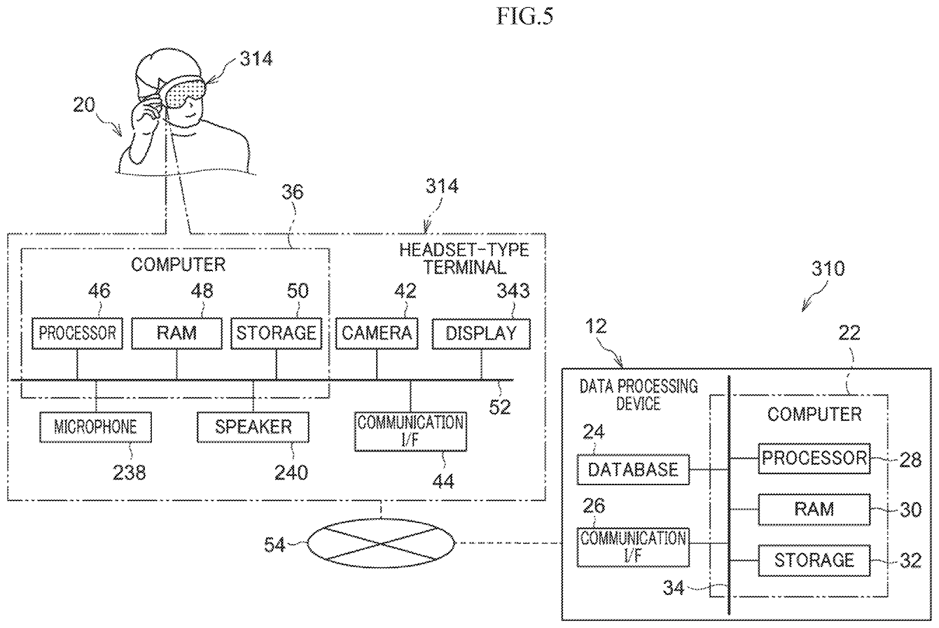

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

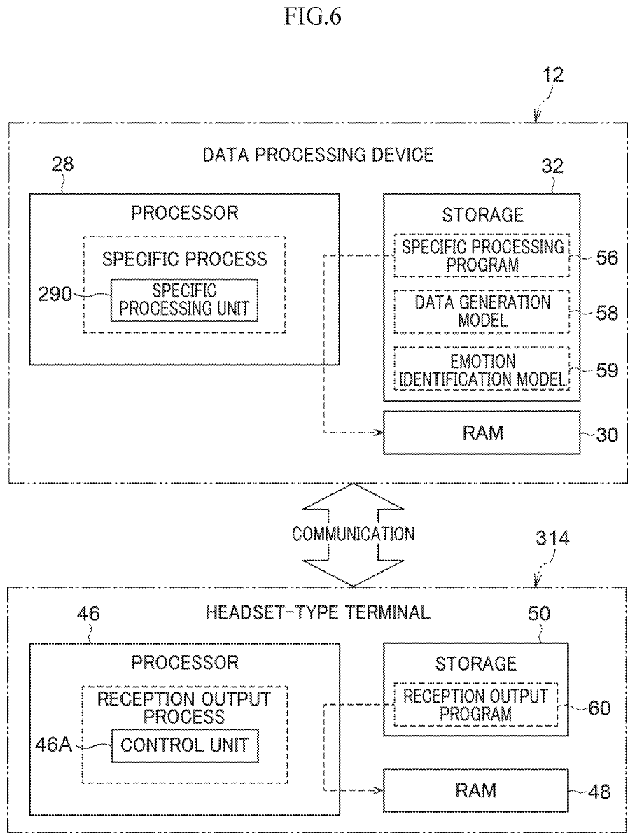

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

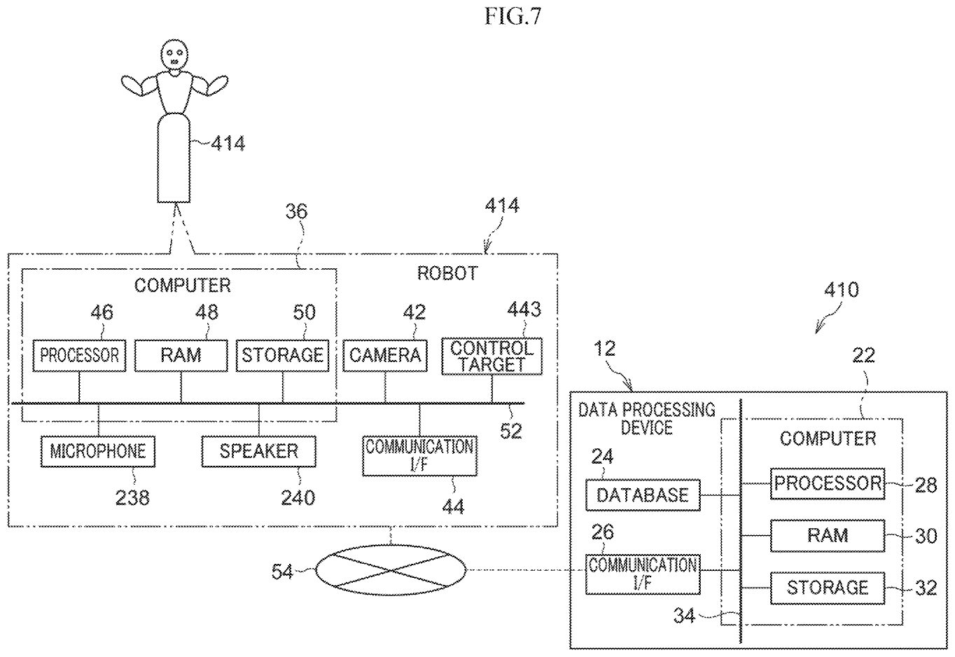

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

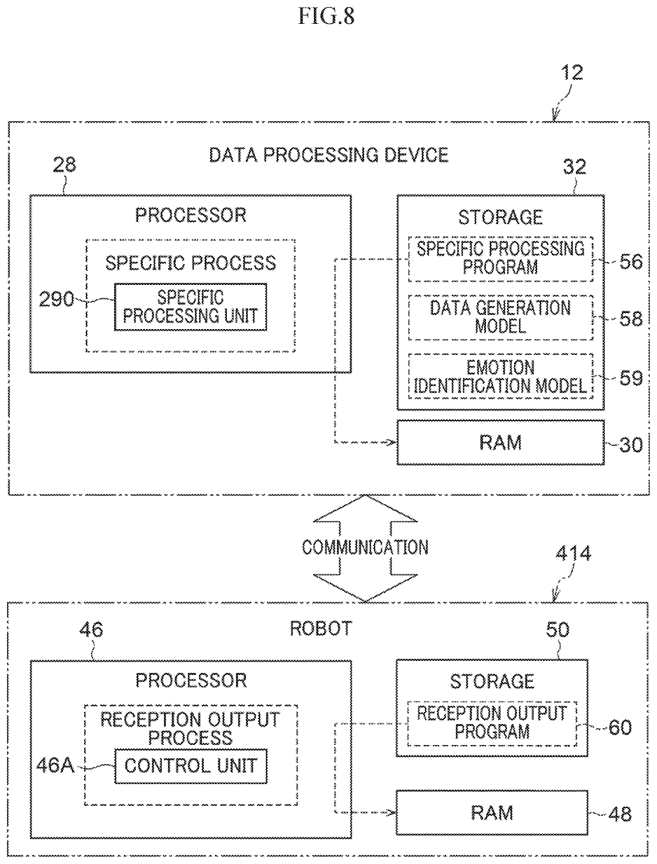

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

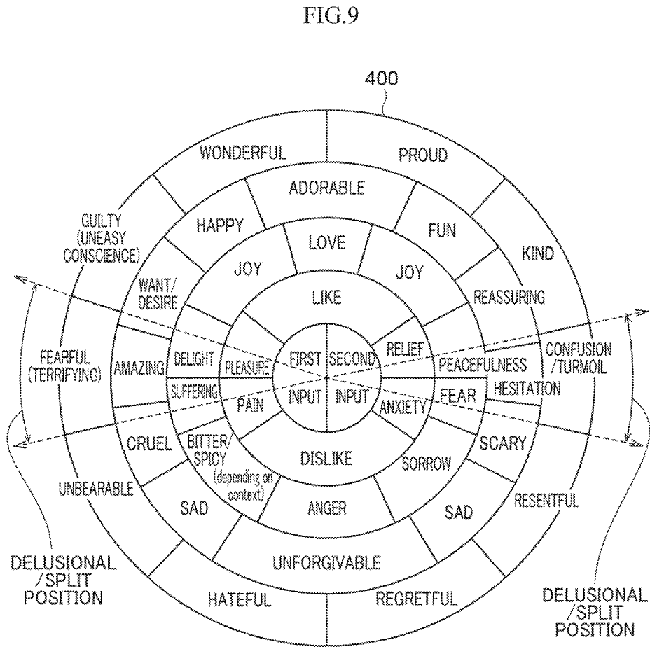

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

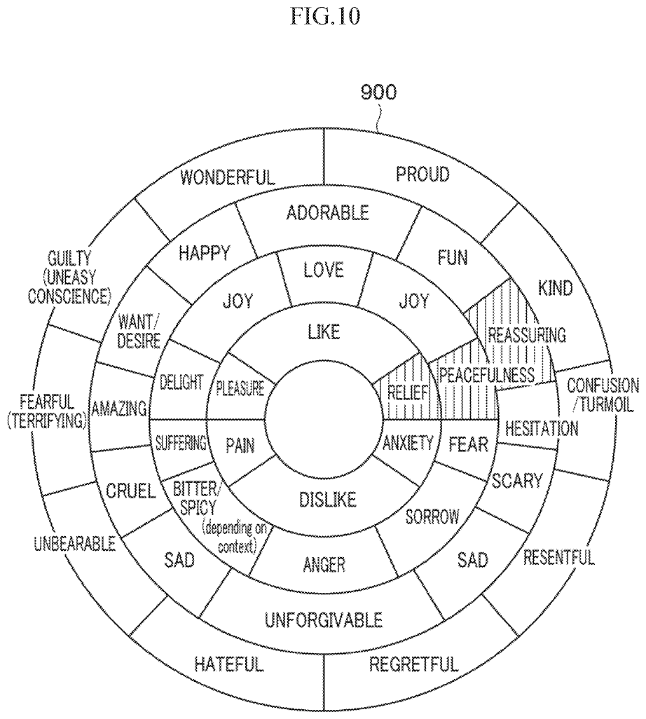

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire audio information as input, execute acoustic analysis processing to extract acoustic feature quantities and a speaker embedding vector from a time-domain or frequency-domain signal, and convert the audio information into audio data in a unified format; and
acquire character information as input, execute language analysis processing to extract sentence-level or word-level structures, frequent terms, expression patterns, and style indices, and generate a language feature profile representing a speaking manner and a thinking pattern of a specific person; and
activate a generative language model based on the character information or external information, generate a prompt sentence for instructing the generative language model to imitate the speaking manner and the thinking pattern of the specific person, and combine the prompt sentence with the language feature profile to output generated text indicating utterance content of the specific person; and
supply the acoustic feature quantities, the speaker embedding vector, and the generated text as input to a speech synthesis model, synthesize an audio waveform by associating text information with a voice quality and prosody of the specific person, and generate audio data that imitates the voice quality and the speaking manner of the specific person; and
receive a generation instruction sentence from a user as input, provide the generation instruction sentence as the prompt sentence to the generative language model to start generation processing of the generated text and the audio data, and provide resulting audio data to a terminal device via an output storage area or a communication line; and
estimate an emotional state of the user from information indicating the emotional state obtained from a sensing device or an input signal, generate control parameters for adjusting intonation, volume, speaking speed, and style level of the voice of the specific person according to the emotional state, and provide the control parameters as prompt conditions or speech synthesis conditions to the generative language model and the speech synthesis model.

### Supplementary 2

The system according to supplementary 1,
wherein the processor is configured to
acquire, as the character information, utterance records of the specific person stored on a recording medium or dialogue histories on an information processing network, perform preprocessing including removal of unnecessary symbols, normalization of a format, segmentation processing, and encoding processing to convert the character information into a data format suitable for the generative language model, and extract statistical information indicating conversation patterns and topic preferences of the specific person from the preprocessed character information and store the statistical information in the language feature profile.

### Supplementary 3

The system according to supplementary 1,
wherein the processor is configured to
acquire, as the character information, explanation information created by a third party with respect to the specific person, perform semantic analysis processing and keyword extraction processing on the explanation information to extract feature quantities indicating personality, role, expertise, and evaluation tendency of the specific person, and add the feature quantities as conditions of generation of the language feature profile and the prompt sentence.

### Application Example 1

### Supplementary 1

A system comprising a processor,
wherein the processor is configured to
receive audio information as input, analyze signal information of the audio information by using acoustic processing technology, extract feature information from the signal information, and convert the feature information into symbolic information, and
receive character information as input, generate a prompt sentence that instructs a generative AI model to imitate a speaking style and a thinking pattern of a specific entity, input the prompt sentence into the generative AI model, and generate character information of an imitation speaking style, and
input the character information of the imitation speaking style, based on the character information and a voice type selected by a user, into a voice processing mechanism that uses acoustic generation technology, and synthesize audio information that imitates an audio feature of the specific entity, and
encode the audio information into distribution information and transmit the distribution information to a utilization terminal, and
estimate an emotional state of the user based on instruction information from the user and the character information of the imitation speaking style, generate a prompt sentence that instructs adjustment of prosody, speed, and speaking style of a voice of the specific entity in accordance with the emotional state, and apply the prompt sentence to the generative AI model and the voice processing mechanism.

### Supplementary 2

The system according to supplementary 1,
wherein the processor is configured to
acquire, as the character information, record information of the specific entity or dialogue content on a communication infrastructure, and preprocess the record information or the dialogue content to convert the record information or the dialogue content into a format suitable for the generative AI model.

### Supplementary 3

The system according to supplementary 1,
wherein the processor is configured to
acquire, as the character information, descriptive information from another subject regarding the specific entity, analyze the descriptive information to extract linguistic features of the specific entity, and reflect the linguistic features in generation of the prompt sentence and the character information of the imitation speaking style.

### Example 2

### Supplementary 1

A system comprising a processor,
wherein the processor is configured to
receive acoustic data as input, analyze an acoustic signal by using an acoustic information processing technique, extract acoustic features from the acoustic signal, and convert the acoustic features into character-based data; and
receive character-based data as input, acquire record data related to a specific subject from a communication network by using an information acquisition function, and perform preprocessing on the record data to convert the record data into an analyzable format; and
receive the preprocessed character-based data as input, train or adjust a generative AI model including a machine learning model, and construct the generative AI model so as to imitate an expression style and a thinking style of the specific subject; and
receive a prompt sentence including instruction content from a user as input, generate model input information by integrating the prompt sentence with condition information indicating the expression style and the thinking style of the specific subject, and instruct the generative AI model to generate a text response based on the model input information; and
recognize an emotional state of the user, generate a prompt sentence including condition information indicating prosodic characteristics and speech style of a voice of the specific subject according to the emotional state, and instruct the generative AI model and an acoustic information generation technique to perform response generation and acoustic data synthesis based on the condition information; and
input character-based output data from the generative AI model to an acoustic data synthesis technique, generate acoustic data imitating voice characteristics and speech style of the specific subject, and provide the character-based output data and the acoustic data to an output device.

### Supplementary 2

The system according to supplementary 1,
wherein the processor is configured to
treat the character-based data as record data or communication history on a communication network concerning the specific subject, and perform the preprocessing by using data processing software and natural language processing software to execute removal of unnecessary information, normalization of character strings, and segmentation into unit elements, thereby converting the character-based data into a data structure suitable for training or adjustment of the generative AI model.

### Supplementary 3

The system according to supplementary 1,
wherein the processor is configured to
treat the character-based data as explanation data created by a third party concerning the specific subject, analyze the explanation data to extract feature values indicating a vocabulary tendency, a writing style tendency, and a thinking tendency of the specific subject, and use the feature values as condition information in the generative AI model.

### Application Example 2

### Supplementary 1

A system comprising a processor,
wherein the processor is configured to
acquire input audio information, analyze an audio signal included in the audio information by using an audio processing technology, extract acoustic features from the audio signal, and convert the audio information into character string information,
acquire the character string information and person information, generate style information for imitating a linguistic expression and a thought pattern of a specific person on the basis of the person information, and construct a prompt sentence including the style information, the character string information, dialogue history information, and external information for input to a generative AI model,
acquire the input audio information and facial image information, estimate an emotional state of a user by using an emotion analysis technology, and generate an emotion-linked prompt sentence for adjusting prosody and a manner of speech of the specific person by adding or changing conditions relating to response tone and speaking style in the prompt sentence in accordance with the emotional state,
acquire a mimic response character string output from the generative AI model, convert the mimic response character string into synthetic audio on the basis of audio features associated with the specific person by using a speech synthesis technology, and adjust a speed, a volume, and prosody of the synthetic audio in accordance with the emotional state to generate an output,
transmit the mimic response character string and the synthetic audio to a terminal device and cause the terminal device to display the mimic response character string and reproduce the synthetic audio by performing communication control, and
store the dialogue history information, the emotional state, and the prompt sentence as accumulated information and refer to the accumulated information as context information when generating a subsequent prompt sentence,
thereby providing styled and emotion-adaptive responses in the manner of the specific person.

### Supplementary 2

The system according to supplementary 1,
wherein the processor is configured to acquire, as the person information, text information including at least one of recorded documents, utterance records, journal information, electronic communication histories, and third-party descriptive documents related to the specific person, perform preprocessing and feature extraction processing on the text information to convert the text information into style information suitable for the generative AI model, and embed a part of the style information as sample sentences into the prompt sentence.

### Supplementary 3

The system according to supplementary 1,
wherein the processor is configured to integrate a voice emotion analysis result based on the input audio information and a facial emotion analysis result based on the facial image information to determine the emotional state of the user, and add, to the prompt sentence, a condition sentence instructing at least one of a consoling response, an encouraging response, a plain explanatory response, and a concise response in accordance with the emotional state.

What is claimed is:

1. A system comprising:
circuitry configured to:
acquire audio information from one or more input sources via a communication interface coupled to a packet-switched network, execute acoustic analysis processing to extract acoustic feature quantities and a speaker embedding vector from a time-domain or frequency-domain signal of the audio information, and convert the audio information into audio data in a unified internal format stored in a memory;
acquire character information from one or more data sources, execute language analysis processing to extract sentence-level and word-level structures, frequent terms, expression patterns, style indices, conversation patterns, and topic preferences from the character information, and generate and store a language feature profile representing a speaking manner and a thinking pattern of a reference entity;
activate a generative language model based on the character information, generate structured prompt sentences for instructing the generative language model to imitate the speaking manner and the thinking pattern of the reference entity, combine the prompt sentences with the language feature profile, and output generated text indicating utterance content of the reference entity;
supply the acoustic feature quantities, the speaker embedding vector, and the generated text to a speech synthesis model, synthesize an audio waveform by associating the generated text with a voice quality and prosody of the reference entity, and generate audio data that imitates the voice quality and speaking manner of the reference entity; and
receive, via the communication interface, a generation instruction sentence from a user terminal, provide the generation instruction sentence as a prompt sentence to the generative language model to start generation processing of the generated text and the audio data, and transmit resulting audio data to the user terminal via the communication interface.

2. The system according to claim 1, wherein the circuitry is configured to estimate an emotional state of the user from information indicating the emotional state obtained from a sensing device or an input signal, generate control parameters for adjusting intonation, volume, speaking speed, and style level of the voice of the reference entity according to the emotional state, and provide the control parameters as prompt conditions and speech synthesis conditions to the generative language model and the speech synthesis model.

3. The system according to claim 2, wherein the circuitry is configured to apply the control parameters to modify at least one of a fundamental frequency contour, an energy envelope, and a speaking rate parameter of the synthesized audio waveform based on the estimated emotional state.

4. The system according to claim 3, wherein the circuitry is configured to dynamically update the control parameters in response to changes in the estimated emotional state detected during a session, and re-invoke the speech synthesis model with updated control parameters to generate revised audio data.

5. The system according to claim 4, wherein the circuitry is configured to record each generation instruction sentence, the corresponding control parameters, and the resulting audio data in an execution log in the memory for audit and reproducibility.

6. The system according to claim 1, wherein the circuitry is configured to acquire, as the character information, utterance records of the reference entity stored on a recording medium or dialogue histories on a communication network, perform preprocessing comprising removal of unnecessary symbols, format normalization, segmentation processing, and encoding processing to convert the character information into a data format suitable for the generative language model, and extract statistical information indicating conversation patterns and topic preferences from the preprocessed character information and store the statistical information in the language feature profile.

7. The system according to claim 6, wherein the circuitry is configured to apply a frequency analysis to the preprocessed character information to identify frequent terms and expression patterns characteristic of the reference entity, and store the identified terms and patterns as weighted entries in the language feature profile.

8. The system according to claim 1, wherein the circuitry is configured to acquire, as the character information, explanation information created by a third party with respect to the reference entity, perform semantic analysis processing and keyword extraction processing on the explanation information to extract feature quantities indicating personality, role, expertise, and evaluation tendency, and add the feature quantities as conditions for generating the language feature profile and the prompt sentences.

9. The system according to claim 1, wherein the acoustic analysis processing applies a mel-frequency cepstral coefficient extraction to the audio information to generate the acoustic feature quantities, and applies a speaker recognition model to generate the speaker embedding vector as a fixed-length numerical representation of speaker-specific properties.

10. The system according to claim 9, wherein the speech synthesis model is conditioned on the speaker embedding vector to generate an audio waveform that reproduces the timbre and prosodic characteristics of the reference entity.

11. The system according to claim 1, wherein the language analysis processing applies tokenization, part-of-speech tagging, and syntactic parsing to the character information to extract the sentence-level and word-level structures.

12. The system according to claim 11, wherein the circuitry is configured to compute style indices from the character information by measuring at least one of vocabulary diversity, sentence length distribution, and use frequency of specific syntactic constructs, and store the computed style indices in the language feature profile.

13. The system according to claim 1, wherein the unified internal format comprises a predetermined sampling rate, bit depth, and channel configuration applied to the audio information to normalize heterogeneous input data for the acoustic analysis processing.

14. The system according to claim 1, wherein the structured prompt sentences incorporate the language feature profile as a context prefix, and the generated text is constrained to conform to the expression patterns and style indices stored in the language feature profile.

15. The system according to claim 1, wherein the circuitry is configured to apply a voice type selection received from the user terminal to select a target voice characteristic from a plurality of stored voice characteristic profiles, and condition the speech synthesis model on the selected voice characteristic in addition to the speaker embedding vector.

16. The system according to claim 15, wherein the circuitry is configured to encode the synthesized audio data into a distribution format and transmit the distribution format to the user terminal via the communication interface.

17. The system according to claim 1, wherein the circuitry is configured to periodically update the language feature profile by re-executing the language analysis processing on newly acquired character information, and apply an update rule to merge the new statistical information with the existing language feature profile entries.

18. A system comprising:
circuitry configured to:
extract acoustic feature quantities and a speaker embedding vector from audio information via acoustic analysis processing, and convert the audio information into audio data in a unified internal format;
generate a language feature profile from character information via language analysis processing, and generate structured prompt sentences that instruct a generative language model to imitate a speaking manner and thinking pattern of a reference entity;
supply the acoustic feature quantities, the speaker embedding vector, and generated text from the generative language model to a speech synthesis model to synthesize audio data that imitates the voice quality and speaking manner of the reference entity; and
estimate an emotional state of a user from a sensing device, generate control parameters for adjusting voice characteristics based on the emotional state, and apply the control parameters to the generative language model and the speech synthesis model.

19. The system according to claim 18, wherein the circuitry is configured to acquire explanation information created by a third party with respect to the reference entity, extract feature quantities indicating personality, role, and expertise via semantic analysis, and incorporate the feature quantities as conditions in the language feature profile and the prompt sentences.

20. A method comprising:
acquiring audio information from one or more input sources via a communication interface coupled to a packet-switched network, executing acoustic analysis processing to extract acoustic feature quantities and a speaker embedding vector from a time-domain or frequency-domain signal of the audio information, and converting the audio information into audio data in a unified internal format stored in a memory;
acquiring character information from one or more data sources, executing language analysis processing to extract sentence-level and word-level structures, frequent terms, expression patterns, style indices, conversation patterns, and topic preferences from the character information, and generating and storing a language feature profile representing a speaking manner and a thinking pattern of a reference entity;
activating a generative language model based on the character information, generating structured prompt sentences for instructing the generative language model to imitate the speaking manner and the thinking pattern of the reference entity, combining the prompt sentences with the language feature profile, and outputting generated text indicating utterance content of the reference entity;
supplying the acoustic feature quantities, the speaker embedding vector, and the generated text to a speech synthesis model, synthesizing an audio waveform by associating the generated text with a voice quality and prosody of the reference entity, and generating audio data that imitates the voice quality and speaking manner of the reference entity; and
receiving, via the communication interface, a generation instruction sentence from a user terminal, providing the generation instruction sentence as a prompt sentence to the generative language model to start generation processing of the generated text and the audio data, and transmitting resulting audio data to the user terminal via the communication interface.
